(19) United States
(12) Patent Application Publication
(10) Pub. No.: US 2025/0066659 A1
(43) Pub. Date: Feb. 27, 2025

(54) CLAY SWELLING INHIBITOR COMPOSITIONS AND METHODS OF USING SAME

(71) Applicant: University of Louisiana at Lafayette, Lafayette, LA (US)

(72) Inventor: Nelson Antonio CHAVEZ, Lafayette, LA (US)

(73) Assignee: University of Louisiana at Lafayette, Lafayette, LA (US)

(21) Appl. No.: 18/680,511

(22) Filed: May 31, 2024

Related U.S. Application Data
(63) Continuation-in-part of application No. 18/510,133, filed on Nov. 15, 2023, now abandoned.
(60) Provisional application No. 63/425,384, filed on Nov. 15, 2022.

(51) Int. Cl. C09K 8/035; C09K 8/03; E21B 33/138

(52) U.S. Cl. CPC C09K 8/035; C09K 8/032; E21B 33/138; C09K 2208/12

(57) ABSTRACT

Disclosed herein are clay swelling inhibitor compositions and methods for using them to treat oil and gas wells and subterranean formations. In a specific embodiment, the clay swelling inhibitor composition includes: calcium chloride from about 40 wt % to about 60 wt %; potassium bicarbonate from about 15 wt % to about 25 wt %; potassium formate from about 25 wt % to about 35 wt %; and additives. In another specific embodiment, the clay swelling inhibitor composition includes: potassium citrate from about 50 wt % to about 60 wt %; cesium formate from about 20 wt % to about 30 wt %; potassium acetate from about 15 wt % to about 25 wt %; and additives.

### CROSS-REFERENCE TO RELATED APPLICATIONS

This application is a continuation of U.S. patent application Ser. No. 18/510,133, filed Nov. 15, 2023, which claims the benefit of U.S. Provisional Patent Application No. 63/425,384, filed Nov. 15, 2022, each of which is incorporated by reference herein in its entirety.

### BACKGROUND

### Field

Clay swelling inhibitor compositions and methods for using them to treat oil and gas wells are described.

### Description of the Related Art

The petroleum industry has been a sustainer of many countries' economies in the world. The industry is the primary source of energy in the world today, and it continues to create jobs for hundreds of thousands of people (Molina, 2022). As energy demand is on the rise, the petroleum industry strives to develop innovative oilfield technologies to recover more oil and gas from reservoirs. In order to access targets in formations with extremely high temperatures and pressures, deeper wells are drilled, and harsh and severe environments are explored for hydrocarbons (Zhong et al., 2012a). Hydrocarbons are formed over a long period of time, under high pressures and high temperatures, from organic matter (particularly marine or swamp plants and animals that existed millions of years ago) in buried sedimentary rocks thousands of meters below the Earth's surface (Bommer, 2008; Nolan, 2014).

Drillers and industrial operators have long dreamt of drilling a functional hole with minimal environmental impact and a low-cost imprint. The drilling fluid also referred to as “the lifeblood of the drilling process,” is a crucial part of the oil well drilling process. It is one of the most significant materials that determine whether the drilling operation is successful or not (Agwu et al., 2015). Site investigations, foundation construction, and oil production commonly utilize water and oil-based muds to facilitate drilling and to stabilize boreholes (Murray, 2006). During the drilling of oil and gas wells, drilling fluids are used to perform various functions such as lubricate drill bits, manage hydro pressure, reduce fluid loss, transmit sensor reading, remove rock cutting, and inhibit swelling of reactive clay-based in reservoir formation (Ahmad et al., 2018; Anderson et al., 2010; Ghavami et al., 2018; Murtaza et al., 2020).

The three most common types of drilling fluids used in the petroleum industry are water-based drilling muds (WBDMs), oil-based drilling muds (OBDMs), and synthetic-based drilling fluids (SBDF) (Agwu et al., 2015). Oil-based fluids have intrinsic advantages such as excellent inhibition, high-temperature stability, and remarkable lubricity. This makes oil-based fluids more suitable to drill through formations containing water-swellable clays (Agwu et al., 2015; Rojas, 2006). However, the use of oil-based drilling muds as drilling fluids have been restricted due to negative environmental impact and high costs (Murtaza et al., 2020). The cuttings from oil-based drilling fluids are significantly more hazardous (Seyedmohammadi, 2017)

Synthetic-based fluids are a new type of drilling mud that is particularly beneficial for deep-water and deviated hole drilling. These fluids are developed as an environmentally friendly alternative to OBFs (Melton, 2004). The environmental implications of discharged drill cuttings with SBDF are not well understood, and the cost of its usage is very high (Dimataris, 2017; Zhong et al., 2012b).

The most desirable type of drilling fluid used currently is water-based drilling fluids (WBDFs). Although water-based drilling fluids are environmentally favorable, cost-effective, user-friendly, and have efficient rheological and drilling performance (Attia, 2010; Du, 2020), they have limitations such as instabilities when exposed to high temperatures and swelling during and after drilling operations remains a major issue (A. M. Tehrani, 2007; Zhong et al., 2012c). The interaction of water-based muds and clays in the reservoir can be detrimental to wellbore stability (B. Kutlu, 2017; F. Salles, 2009). During the preparation of WBDF additives are added to the mixture. These additives are grouped into 16 functional categories, and each of these categories may contain other alternatives with slightly different properties (ASME, 2005).

Recently several types of non-conventional clay inhibitors have been used in the industry (Muhammed et al., 2021). These inhibitors are mostly organic and inorganic based, ionic liquids (cation and anions) (Yuan et al., 2019), surfactants (Ahmadi, 2018; Quainoo et al., 2020) (chemical and bio-based extracts), and nanomaterials (Lv et al., 2020).

These commonly used commercial clay inhibitors have many drawbacks. Potassium chloride which is considered the practical and economical of all the inorganic inhibitors used in water-based muds is detrimental to the environment. The use of potassium chloride as a clay swelling inhibitor pollutes the environment hence many environmental agencies do not allow the use of more than 5% of its concentration during drilling and drilling operations. Other inhibitors such as ammonium chloride, tetramethylammonium chloride, and cesium formate are effective in controlling clay swelling but they are expensive hence many companies don't use them in the preparation of water-based muds.

Consequently, there is a need for new clay swelling inhibitor compositions that can be used to treat oil and gas wells to prevent damage to subterranean formations.

### SUMMARY

Provided herein are clay swelling inhibitor compositions and methods that can be used to treat subterranean formations for oil and gas production. In a specific embodiment, the clay swelling inhibitor composition includes: calcium chloride, where the calcium chloride is present in the clay swelling inhibitor composition from about 40 wt % to about 60 wt %; potassium bicarbonate, where the potassium bicarbonate is present in the clay swelling inhibitor composition from about 15 wt % to about 25 wt %; potassium formate, where the potassium formate is present in the clay swelling inhibitor composition from about 25 wt % to about 35 wt %; and additives.

In another specific embodiment, the clay swelling inhibitor composition includes: potassium citrate, where the potassium citrate is present in the clay swelling inhibitor composition about 50 wt % to about 60 wt %; cesium formate, where the cesium formate is present in the clay swelling inhibitor composition from about 20 wt % to about 30 wt %; potassium acetate, where the potassium acetate is present in the clay swelling inhibitor composition from about 15 wt % to about 25 wt %; and additives.

In another specific embodiment, the method of treating a well or subterranean formation includes: injecting a clay swelling inhibitor composition into a wellbore, where the clay swelling inhibitor composition comprises: cesium formate, where the cesium formate is present in the clay swelling inhibitor composition from about 40 wt % to about 60 wt %; potassium acetate, where the potassium acetate is present in the clay swelling inhibitor composition from about 25 wt % to about 50 wt %; and additives.

In yet another specific embodiment, the method of treating a well or subterranean formation includes: injecting a clay swelling inhibitor composition into a wellbore, where clay swelling inhibitor composition comprises: polypropylene glycol, where the polypropylene glycol is presented in the well treatment fluid from about 45 wt % to about 60 wt %; cesium formate, where the cesium formate is present in the clay swelling inhibitor composition from about 15 wt % to about 30 wt % potassium acetate, where the potassium acetate is present in the clay swelling inhibitor composition from about 15 wt % to about 30 wt %; and additives.

### BRIEF DESCRIPTION OF THE DRAWINGS

For the purposes of promoting an understanding of the principles of the present disclosure, reference is now made to the embodiments illustrated in the drawings, which are described below. The embodiments disclosed herein are not intended to be exhaustive or limit the present disclosure to the precise form disclosed in the following detailed description. Rather, the embodiments are chosen and described so that others skilled in the art can utilize their teachings. Therefore, no limitation of the scope of the present disclosure is thereby intended.

FIG. 1 depicts octahedral and tetrahedral layers in clays (Murray, 2007).

FIG. 2 depicts layers of partially dehydrated vermiculite combined with layers of water (Hendricks, 1938).

FIG. 3 depicts a schematic representation of clay swelling inhibition mechanism: without cationic inhibitors' action (left), and under the cationic inhibitors' action (right) (Balaban et al., 2015).

FIG. 4 are the SEM images of Na bentonite used for experimentation at 3500 and 6500 magnifications.

FIG. 5 are the SEM images of Ca bentonites.

FIG. 6 is a graph of the CST results for novel inhibitors at 3%, 4%, and 5% concentrations mixed with Ca bentonite and drilling fluids.

FIG. 7 is a graph of the depicting filtration time test results for 5% inhibitors mixed with Na bentonite and water.

FIG. 8 is a graph of the depicting filtration time test results for 5% inhibitor mixed with Ca bentonite and water.

FIG. 9 is a graph of the depicting the linear swelling test for 3% and 5% concentration mixed with Na bentonite.

FIG. 10 is a graph of the depicting the linear swelling test Ca bentonite samples.

FIG. 11 is a graph depicting the Accretion Cutting test results for inhibitors mixed with Pierre Type II shale samples.

FIG. 12 is a graph of the depicting the inhibition evaluation on the Pierre Type II.

FIG. 13 depicts a mechanism of osmotic swelling (Rahman et al., 2020).

FIG. 14 shows the filtration time test setup.

FIG. 15 is a graph of dehydration curves for Na and Ca bentonite.

FIG. 16 is an FTIR spectrum of Ca bentonite before drying.

FIG. 17 is an FTIR spectrum of Ca bentonite after drying at 250° C.

FIG. 18 is an FTIR spectrum of wet Na bentonite.

FIG. 19 is an FTIR spectrum of Na bentonite after drying at 250° C.

FIG. 20 shows the WPPF for Na bentonite.

FIG. 21 shows the WPPF for Ca bentonite.

FIG. 22 shows the XRD analysis on Ca and Na bentonite at Core Lab optimization.

FIG. 23 shows the EDS peaks for Na bentonite.

FIG. 24 shows the EDS peaks for Ca bentonite.

FIG. 25 is a graph of the CST results for commercial inhibitor concentrations of 3%, 4%, and 5% mixed with Na bentonite.

FIG. 26 is a graph of the CST data for 3%, 4% and 5% concentration of inhibitors produced by Chemical inhibitors mixed with Na bentonite.

FIG. 27 is a graph of the CST results for commercial inhibitors 3%, 4%, and 5% concentrations mixed with Ca bentonite and drilling fluids.

FIG. 28 shows the ionic radius and hydration energy of cations (Chuprin et al., 2020).

FIG. 29 is a graph of the depicting the filtration time test results for 5% commercial clay inhibitor mixed with Na bentonite and water.

FIG. 30 is a graph of the depicting filtration time test results for 5% commercial clay inhibitor mixed with Ca bentonite and water.

FIG. 31 is a graph of depicting the filtration time test for 4% concentration of commercial inhibitors mixed with water and Na bentonite.

FIG. 32 is a graph of depicting the filtration time test for 4% concentration of commercial inhibitors mixed with water and Ca bentonite.

FIG. 33 is a graph of depicting the filtration time test for 4% concentration of inhibitors mixed with water and Ca bentonite.

FIG. 34 is a graph of depicting the filtration time test for 4% concentration of commercial inhibitors mixed with water and Na bentonite.

FIG. 35 is a graph of depicting the filtration time test for 3% concentration of commercial inhibitors mixed with water and Na bentonite.

FIG. 36 is a graph of depicting the filtration time test for 3% concentration of inhibitors mixed with water and Ca bentonite.

FIG. 37 is a graph of depicting the filtration time test for 3% concentration of inhibitors mixed with water and Na bentonite.

FIG. 38 is a graph of depicting the filtration time test for 3% concentration of inhibitors mixed with water and Ca bentonite.

### DETAILED DESCRIPTION

In one or more embodiments, the clay swelling inhibitor compositions can include, but is not limited: one or more inorganic salts, one or more organic salts, one or more acids, one or more bases, one or more polymers, one or more solvents and/or carrier fluids, and one or more additives.

The one or more inorganic salts can include, but is not limited to: cesium formate (HCOOCs), sodium chloride (NaCl), sodium carbonate (Na₂CO₃), sodium bicarbonate (NaHCO₃), potassium chloride (KCl), potassium carbonate (K₂CO₃), potassium bicarbonate (KHCO₃), potassium fluoride (KF), sodium fluoride (NaF), potassium formate (HCOOK), sodium formate (HCOONa), calcium chloride (CaCl₂)), ammonium carbonate ((NH4)₂CO₃), ammonium chloride (NH₄Cl), tetramethylammonium chloride (N(CH₃)₄Cl), sodium chloride (NaCl), potassium chloride (KCl), and mixtures thereof. The cesium formate can include a chemical structure shown below:

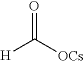

The potassium acetate can include a chemical structure shown below:

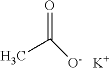

The one or more clay swelling inhibitor compositions can have a content of the one or more inorganic salts the varies widely. For example, the clay swelling inhibitor compositions can have a content of the one or more inorganic salts from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more inorganic salts from about 0.1 wt % to about 99.9 wt %, about 0.1 wt % to about 25.0 wt %, about 1.0 wt % to about 99.0 wt %, about 10.0 wt % to about 90.0 wt %, about 10.0 wt % to about 20.0 wt %, about 15.0 wt % to about 25.0 wt %, about 15.0 wt % to about 30.0 wt %, about 15.0 wt % to about 35.0 wt %, about 20.0 wt % to about 30.0 wt %, about 25.0 wt % to about 50.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 45.0 wt % to about 60.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more inorganic salts. The weight percent of the one or more inorganic salts in the clay swelling inhibitor compositions can be based on the total weight of the clay swelling inhibitor composition, or based on the total weight of the one or more inorganic salts, one or more organic salts, one or more acids, one or more bases, one or more polymers, one or more solvents and/or carrier fluids, and one or more additives.

The one or more organic salts can include, but is not limited: dipotassium glutarate (C₅H₆K₂O₄), disodium glutarate (C₅H₆K₂O₄), sodium citrate (Na₃C₆H₅O₇), potassium citrate (K₃C₆H₅O₇), potassium acetate (CH₃CO₂K), choline chloride [((CH₃)₃NCH₂CH₂OH)Cl], sodium acetate (CH₃CO₂Na), and mixtures thereof. The one or more clay swelling inhibitor compositions can have a content of the one or more organic salts the varies widely. For example, the clay swelling inhibitor compositions can have a content of the one or more organic salts from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more organic salts from about 0.1 wt % to about 99.9 wt %, about 0.1 wt % to about 25.0 wt %, about 1.0 wt % to about 99.0 wt %, about 10.0 wt % to about 90.0 wt %, about 10.0 wt % to about 20.0 wt %, about 15.0 wt % to about 25.0 wt %, about 15.0 wt % to about 30.0 wt %, about 15.0 wt % to about 35.0 wt %, about 20.0 wt % to about 30.0 wt %, about 25.0 wt % to about 50.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 45.0 wt % to about 60.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more organic salts. The weight percent of the one or more organic salts in the clay swelling inhibitor compositions can be based on the total weight of the clay swelling inhibitor composition, or based on the total weight of the one or more inorganic salts, one or more organic salts, one or more acids, one or more bases, one or more polymers, one or more solvents and/or carrier fluids, and one or more additives.

The one or more bases can include, but is not limited to: calcium hydroxide [Ca(OH)₂], sodium hydroxide (NaOH), potassium hydroxide (KOH), and mixtures thereof. The one or more clay swelling inhibitor compositions can have a content of the one or more bases the varies widely. For example, the clay swelling inhibitor compositions can have a content of the one or more bases from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more bases from about 0.1 wt % to about 99.9 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more bases. The weight percent of the one or more bases in the clay swelling inhibitor composition can be based on the total weight of the clay swelling inhibitor composition, or based on the total weight of the one or more inorganic salts, one or more organic salts, one or more acids, one or more bases, one or more polymers, one or more solvents and/or carrier fluids, and one or more additives.

The one or more bases can include, but is not limited to: hydrochloric acid (HCl), carbonic acid (H₂CO₃), formic acid (CH₂O₂), citric acid (C₆H₈O₇), and mixtures thereof. The one or more clay swelling inhibitor compositions can have a content of the one or more acids the varies widely. For example, the clay swelling inhibitor compositions can have a content of the one or more acids from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more acids from about 0.1 wt % to about 99.9 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more acids. The weight percent of the one or more acids in the clay swelling inhibitor compositions can be based on the total weight of the clay swelling inhibitor composition, or based on the total weight of the one or more inorganic salts, one or more organic salts, one or more acids, one or more bases, one or more polymers, one or more solvents and/or carrier fluids, and one or more additives.

The one or more polymers can include, but is not limited: one or more polypropylene glycol, one or more polyacrylamide and mixtures thereof. The one or more clay swelling inhibitor compositions can have a content of the one or more polymers the varies widely. For example, the clay swelling inhibitor compositions can have a content of the one or more polymers from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more polymers from about 0.1 wt % to about 99.9 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more polymers. The weight percent of the one or more polymers in the clay swelling inhibitor compositions can be based on the total weight of the clay swelling inhibitor composition, or based on the total weight of the one or more inorganic salts, one or more organic salts, one or more acids, one or more bases, one or more polymers, one or more solvents and/or carrier fluids, and one or more additives.

The chemical formula for the polypropylene glycol can include:

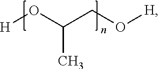

where n is an integer from a low 1 to a high of 5,000. The polypropylene glycol can have a weight-average molecular weight (M_{w}) that varies widely. For example, the polypropylene glycol can have a weight-average molecular weight from a low of about 300 g/mol, about 3,000 g/mol, or about 10,000 g/mol, to a high of about 80,000 g/mol, about 100,000 g/mol, or about 200,000 g/mol. In another example, the polypropylene glycol can have a weight-average molecular weight that is less than 8,000 g/mol, less than 5,000 g/mol, or less than 1,000 g/mol. In another example, the polypropylene glycol can have a weight-average molecular weight from about 300 g/mol to about 200,000 g/mol, about 300 g/mol to about 1,200 g/mol, about 1,000 g/mol to about 10,000 g/mol, about 2,000 g/mol to about 50,000 g/mol, about 100,000 g/mol to about 200,000 g/mol. The molecular weight of the polypropylene glycol can be measured by gel permeation chromatography with tri-detectors.

The polypropylene glycol can have a number-average molecular weight (Mₙ) that varies widely. For example, the polypropylene glycol can have a number-average molecular weight from a low of about 300 g/mol, about 1,000 g/mol, or about 3,000 g/mol, to a high of about 80,000 g/mol, about 100,000 g/mol, or about 200,000 g/mol. In another example, the polypropylene glycol can have a number-average molecular weight that is less than 500 g/mol, less than 6,000 g/mol, or less than 10,000 g/mol. In another example, the polypropylene glycol can have a number-average molecular weight from about 300 g/mol to about 2,000 g/mol, about 3,000 g/mol to about 20,000 g/mol, about 2,000 g/mol to about 8,000 g/mol, about 40,000 g/mol to about 80,000 g/mol, about 100,000 g/mol to about 200,000 g/mol.

The chemical formula for the polyacrylamide can include:

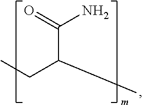

where m is an integer from a low 1 to a high of 5,000. The polyacrylamide can have a weight-average molecular weight (M_{w}) that varies widely. For example, the polyacrylamide can have a weight-average molecular weight from a low of about 300 g/mol, about 15,000 g/mol, or about 4,000 g/mol, to a high of about 80,000 g/mol, about 90,000 g/mol, or about 200,000 g/mol. In another example, the polyacrylamide can have a weight-average molecular weight that is less than 80,000 g/mol, less than 60,000 g/mol, or less than 50,000 g/mol. In another example, the polypropylene glycol can have a weight-average molecular weight from about 300 g/mol to about 2,000 g/mol, about 3,000 g/mol to about 200,000 g/mol, about 20,000 g/mol to about 80,000 g/mol, about 40,000 g/mol to about 80,000 g/mol, about 100,000 g/mol to about 200,000 g/mol. The molecular weight of the polyacrylamide can be measured by gel permeation chromatography with tri-detectors.

The polypropylene glycol can have a number-average molecular weight (Mₙ) that varies widely. For example, the polypropylene glycol can have a number-average molecular weight from a low of about 300 g/mol, about 3,000 g/mol, or about 4,000 g/mol, to a high of about 80,000 g/mol, about 100,000 g/mol, or about 200,000 g/mol. In another example, the polypropylene glycol can have a number-average molecular weight that is less than 1,000 g/mol, less than 6,000 g/mol, or less than 10,000 g/mol. In another example, the polypropylene glycol can have a number-average molecular weight from about 300 g/mol to about 25,000 g/mol, about 30,000 g/mol to about 200,000 g/mol, about 20,000 g/mol to about 80,000 g/mol, about 40,000 g/mol to about 80,000 g/mol, about 100,000 g/mol to about 200,000 g/mol.

The one or more solvents and/or carrier fluids, can include, but is not limited to: water, hexanes, toluene, methanol, ethanol, propanol, isopropanol, acetone, acetonitrile, chloroform, diethyl ether, methylene chloride, dimethyl formamide, ethylene glycol, propylene glycol, triethylamine, tetrahydrofuran, and mixtures thereof.

The one or more additives can include, but is not limited to: one or more weighting materials, one or more viscosifiers, one or more thinners, one or more dispersants, one or more temperature stability agents, one or more flocculants, one or more filtrate reducers, one or more pH control additives, one or more lost circulation materials, one or more lubricants, one or more shale control materials, one or more emulsifiers, one or more surfactants, one or more bactericides, one or more pipe-freeing agents, one or more corrosion inhibitors, one or more scale inhibitors, one or more breakers, one or more proppants, one or more friction reducers, one or more solvents and/or carrier fluid, and mixtures thereof. The one or more additives can include, but is not limited to, those chemicals listed in Table 1.

TABLE 1
Functional categories of materials used in WBF, their functions,
and examples of typical chemicals in each category (ASME, 2005)

| [symbol] | [symbol] | [symbol] |
|---|---|---|
| [symbol] | [symbol] | [symbol] |

[symbol]

indicates data missing or illegible when filed

The one or more clay swelling inhibitor compositions can have a content of the one or more additives the varies widely. For example, the clay swelling inhibitor compositions can have a content of the one or more additives from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more additives from about 0.1 wt % to about 99.9 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more additives. The weight percent of the one or more additives in the clay swelling inhibitor compositions can be based on the total weight of the clay swelling inhibitor composition or based on the total weight of the one or more inorganic salts, one or more organic salts, one or more acids, one or more bases, one or more polymers, one or more solvents and/or carrier fluids, and one or more additives.

The one or more clay swelling inhibitor compositions can have a content of the one or more solvents and/or carrier fluids the varies widely. For example, the clay swelling inhibitor compositions can have a content of the one or more solvents and/or carrier fluids from a low of about 0.1 wt %, about 1.0 wt %, or about 5.0 wt %, to a high of about 90.0 wt %, about 95.0 wt %, or about 99.9 wt %. In another example, the clay swelling inhibitor compositions can have a content of the one or more solvents and/or carrier fluids from about 0.1 wt % to about 99.9 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. In another example, the clay swelling inhibitor compositions can be free of the one or more solvents and/or carrier fluids. The weight percent of the one or more solvents and/or carrier fluids in the clay swelling inhibitor compositions can be based on the total weight of the clay swelling inhibitor composition or based on the total weight of the one or more inorganic salts, one or more organic salts, one or more acids, one or more bases, one or more polymers, one or more solvents and/or carrier fluids, and one or more additives.

The clay swelling inhibitor compositions can have a viscosity that can vary widely. For example, the clay swelling inhibitor compositions can have a viscosity from a low of about 100 cP, about 1,000 cP, or about 100,000 cP, to a high of about 250,000 cP, about 900,000 cP, or about 2,500,000 cP. In another example, the clay swelling inhibitor compositions can have a viscosity from about 100 cP to about 2,500,000 cP, about 1,000 cP to about 250,000 cP, about 2,500 cP to about 250,000 cP, about 2,500 cP to about 200,000 cP, about 10,000 cP to about 100,000 cP, about 10,000 cP to about 50,000 cP, about 100,000 cP to about 250,000 cP, about 620,000 cP to about 850,000 cP, about 700,000 cP to about 750,000 cP, about 700,000 cP to about 800,000 cP, about 650,000 cP to about 855,000 cP, about 700,000 cP to about 800,000 cP, about 500,000 cP to about 1,000,000 cP, or about 500,000 cP to about 2,500,000 cP. The viscosity of the clay swelling inhibitor composition can be measured on a Brookfield viscosimeter. The viscosity of the clay swelling inhibitor compositions can be measured at various temperatures, such as 25° C., 40° C., 60° C., and 100° C.

In some embodiments, the clay swelling inhibitor composition can include: about 45 wt % to about 55 wt % of calcium chloride, about 15 wt % to about 25 wt % of potassium bicarbonate, and about 15 wt % to about 25 wt % of potassium formate. For example, the clay swelling inhibitor composition can include: about 50 wt % of calcium chloride, about 20 wt % of potassium bicarbonate, and about 20 wt % of potassium formate.

In some embodiments, the clay swelling inhibitor composition can include: about 35 wt % to about 45 wt % of potassium acetate, about 25 wt % to about 35 wt % of sodium chloride, about 15 wt % to about 25 wt % of ammonium carbonate, and about 5 wt % to about 10 wt % of ammonium chloride. For example, the clay swelling inhibitor composition can include: about 40 wt % of potassium acetate, about 30 wt % of sodium chloride, about 20 wt % of ammonium carbonate, and about 10 wt % of ammonium chloride.

In some embodiments, the clay swelling inhibitor composition can include: about 55 wt % to about 65 wt % of polypropylene glycol, about 30 wt % to about 40 wt % of potassium acetate, about 1 wt % to about 5 wt % of potassium chloride, and about 1 wt % to about 5 wt % of ammonium chloride. For example, the clay swelling inhibitor composition can include: about 60 wt % of polypropylene glycol, about 35 wt % of potassium acetate, about 3 wt % of potassium chloride, and about 2 wt % of ammonium chloride.

In some embodiments, the clay swelling inhibitor composition can include: about 50 wt % to about 60 wt % of potassium citrate, about 20 wt % about 30 wt % of cesium formate, and about 15 wt % to about 25 wt % of potassium acetate. For example, the clay swelling inhibitor composition can include: about 55 wt % of potassium citrate, about 25 wt % of cesium formate, and about 20 wt % of potassium acetate.

In some embodiments, the clay swelling inhibitor composition can include: about 50 wt % about 60 wt % of polypropylene glycol, about 20 wt % about 30 wt % of cesium formate, and about 15 wt % to about 25 wt % of potassium acetate. For example, the clay swelling inhibitor composition can include: about 55 wt % of polypropylene glycol, about 25 wt % of cesium formate, and about 20 wt % of potassium acetate.

In some embodiments, the clay swelling inhibitor composition can include: about 44 wt % to about 50 wt % potassium acetate and about 50 wt % to about 56 wt % of cesium formate. In another specific embodiment, the clay swelling inhibitor composition can include: about potassium acetate 47 wt % potassium acetate and about 53 wt % of cesium formate.

In some embodiments, the clay swelling inhibitor compositions can be used in or mixed with well drilling fluids, well completion fluids, and well treatment fluids. The clay swelling inhibitor compositions can be used in oil-based well treatment fluids, synthetic-based well treatment fluids, and water-based well treatment fluids. In one or more embodiments, the method of using the clay swelling inhibitor compositions can include, but is not limited to: injecting a clay swelling inhibitor composition down a wellbore.

In some embodiments, the clay swelling inhibitor compositions can mix with a drilling fluid downhole, in situ, during the drilling process. In some embodiments, the potassium bicarbonate of the clay swelling inhibitor compositions can decompose to potassium carbonate according to the chemical equation: 2 KHCO₃→K₂CO₃+CO₂+H₂O. In some embodiments, the potassium carbonate can increase the inhibition process. For example, the produced potassium carbonate can protect the montmorillonite-smectite from swelling, preventing the water from penetrating its chemical structure. In some embodiments, the potassium carbonate can provide effective water absorbent capacity, giving the clay swelling inhibitor compositions a high performance of inhibition. In some embodiments, the decomposition of potassium bicarbonate to potassium carbonate can occur downhole when the clay swelling inhibitor compositions reach a temperature from about 100° C. to about 120° C.

In some embodiments, the well treatment compositions can have a content of the one or more clay swelling inhibitor compositions the varies widely. For example, the well treatment compositions can have a content of the one or more clay swelling inhibitor compositions from a low of about 0.1 wt %, about 1.0 wt %, or about 5.0 wt %, to a high of about 90.0 wt %, about 95.0 wt %, or about 99.9 wt %. In another example, the well treatment compositions can have a content of the one or more clay swelling inhibitor compositions from about 0.1 wt % to about 99.9 wt %, about 1.0 wt % to about 3.0 wt %, about 2.0 wt % to about 3.0 wt %, about 2.0 wt % to about 5.0 wt %, about 1.0 wt % to about 99.0 wt %, about 10.0 wt % to about 90.0 wt %, about 10.0 wt % to about 20.0 wt %, about 20.0 wt % to about 30.0 wt %, about 25.0 wt % to about 75.0 wt %, about 20.0 wt % to about 80.0 wt %, about 20.0 wt % to about 30.0 wt %, about 20.0 wt % to about 60.0 wt %, about 30.0 wt % to about 40.0 wt %, about 30.0 wt % to about 70.0 wt %, about 40.0 wt % to about 60.0 wt %, about 45.0 wt % to about 55.0 wt %, about 40.0 wt % to about 50.0 wt %, about 69.0 wt % to about 75.0 wt %, about 68.0 wt % to about 82.0 wt %, about 72.0 wt % to about 86.0 wt %, about 50.0 wt % to about 73.0 wt %, about 33.0 wt % to about 48.0 wt %, about 60.0 wt % to about 70.0 wt %, about 71.0 wt % to about 81.0 wt %, about 20.0 wt % to 30.0 wt %, about 50.0 wt % to about 60.0 wt %, or about 70.0 wt % to about 80.0 wt %. The weight percent of the one or more clay swelling inhibitor compositions in the well treatment compositions can have a content of can be based on the total weight of the well treatment composition, or based on the total weight of the one or more inorganic salts, one or more organic salts, one or more acids, one or more bases, one or more polymers, one or more solvents and/or carrier fluids, and one or more additives.

In preparing the water-based fluid, one major component used is bentonite. This bentonite acts as a viscosifier to increase the viscosity of the drilling fluids to suspend cutting in the mud during drilling (ASME, 2005). Bentonite also known as montmorillonite contains a higher amount of minerals from the smectite group, which when in contact with water, their volume increases causing swelling (Alsabaa et al., 2020). A variety of types of bentonite exist, depending on the elements that dominate their structure, such as calcium (Ca), potassium (K), aluminum (Al), or sodium (Na) (Ghaedi, 2021).

In preparing the water-based fluid, one major component used is water, which is the continuous phase of the fluid prepared. But for some of the drilling fluids, sodium bentonite is added to act as a viscosifier to increase the viscosity of the drilling fluids to suspend cutting in the mud to the surface where it will be separated mechanically. So, the main function of the clay swelling inhibitor added to the drilling fluid is to protect the clays falling out of the wall of the hole from being swollen and to protect the cutting from being dissolved in the drilling fluids, otherwise, the dissolving cutting will produce formation damage due to the changes of the rheological properties of the drilling fluid, and if the cutting is not suspended to the surface, then, the cutting could get into the bottom of the bit blocking it and allowing the drill pipe stuck.

Na-bentonite is mostly used in the preparation of drilling fluids because it has good dispersion stability, high swelling capacity, and outstanding rheological properties. Whiles, Ca bentonite is cheaper and more abundant but has low rheological properties and forms unstable suspensions with a high settling rate (Ahmadi, 2018; Li et al., 2018). The addition of other minerals like Fe₂O₃, and soda ash (Na₂CO₃) to Ca bentonite can improve their rheological properties that can be used as suspending agent in drilling fluids (Amer, 2022)

The swelling of sodium bentonite when it interacts with water can be minimized using inorganic and organic chemical inhibitors. Organic and inorganic swelling inhibitors prevent water molecules from adsorbing onto clay minerals, thereby reducing their hydration (Balaban et al., 2015).

Clay inhibitors mostly used are grouped as either conventional or non-conventional (Muhammed et al., 2021). A common type of conventional clay inhibitors used is inorganic salts which include Sodium Chloride (NaCl), Potassium Chloride (KCl), Calcium Chloride (CaCl₂)), Ammonium Chloride (NH₄Cl), and divalent brine electrolyte solutions (Ahmed et al., 2019). A thorough explanation of the physics of these cationic stabilizer interactions with clay platelets was given by (Weaver et al., 2011). An octahedral layer of oxides and hydroxyls surrounding aluminum is sandwiched between two tetrahedral layers of oxides surrounding silicon in each platelet of montmorillonite. Because each platelet's outer surface has a net negative charge, cationic stabilizers can be positioned in between the platelets. The stabilizer is very resistant to ion exchange because it is poly-ionic and binds to several locations on platelets. This prevents the clay from absorbing water and forces the platelets into a more stable shape.

Clay swelling during drilling and drilling operations is one of the challenges faced in the oil industry. Both oil-based and synthetic-based muds are quite successful at reducing clay swelling but the environmental pollution concerns of oil-based muds and the high cost of synthetic-based muds curtail their usage.

### Clay Structure

Clays are naturally occurring layered minerals that are formed by weathering and decomposition of igneous rocks (Grim, 1968; Murray H H, 2007). (Brewer, 1964) defines the clay structure as the size, shape, and arrangement of the soil particles and voids including both primary particles to form compound particles and the arrangement of compound particles themselves.

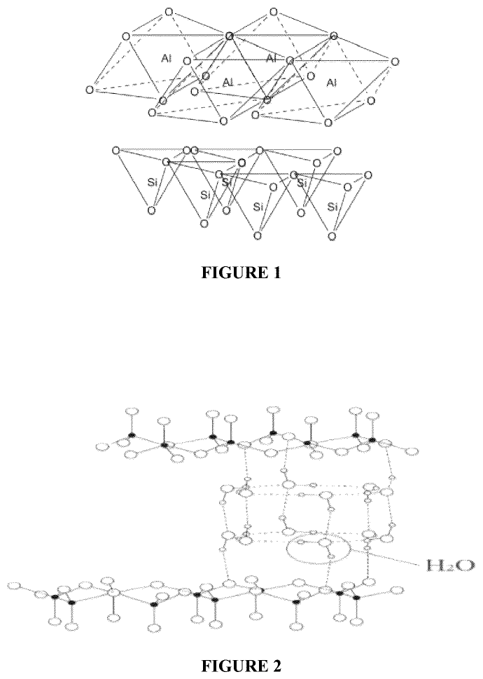

Clay minerals are mostly characterized by their structure and layer type. A clay particle is the general structural unit of the clay structure. The clay particle consists of preferential aligned individual layers of clay mineral units (platelets). The number of interlayer units forming a particle can depend on various factors including the mineral type, matrix potential, and pore chemistry (Kodikara, 1999). Fused sheets of octahedral of Al⁺³, Mg⁺², or Fe⁺³ oxides and sheets of tetrahedral of Si⁺⁴ oxides make up each layer of clay. (Auerbach S M, 2004). A clay mineral is referred to as a 1:1 clay if it is made up of one tetrahedral and one octahedral sheet, whiles a 2:1 clay is defined as one that has two tetrahedral sheets sandwiching one core octahedral sheet. (“Clay Stabilization,” 2015). FIG. 1 shows the octahedral and tetrahedral layers. Metal atoms in the clay lattice can be appropriately substituted, resulting in an overall negative charge on individual clay layers.

Individual clay layers can have a negative charge due to the isomorphic replacement of metal atoms in the clay lattice. This charge is balanced by cations found in the interlayer area, which is located between the clay layers. These interlayer cations are interchangeable and can swap positions with other cations under the right set of circumstances. Clay minerals' cation exchange capacity (CEC) is determined by crystal size, pH, and the type of exchangeable cation (Kloprogge, 1998).

The charge-balancing interlayer cations in naturally occurring clays vary, and they tend to be tiny inorganic species like Na⁺ and Ca²⁺ cations (Blachier et al., 2009; Karpiński & Szkodo, 2015a). The clay lattice's metal atoms can be replaced with others. When an atom of Al⁺³ is substituted with an atom of Mg⁺², results in charge deficiency. Cations in the interlayer area, which may readily interchange charges, compensate for this charge deficiency. The exchangeable cations have an impact on properties such as swelling, dispersion, rheological, and filtering characteristics in drilling fluids technology.

The law of mass action governs the exchange reaction principally by the relative concentrations of distinct species of ions in each phase (Blachier et al., 2009). For two monovalent ions, the equation can be stated as follows:

[A]s/[B]c=k[A]s/[B]s,
where [A]s and [B]s are the molecular concentrations of the two ion species in the solution, and [A]c and [B]c are the molecular concentrations of the clay. K is the ion exchange equilibrium constant, e.g., when K is greater than unity, A is preferentially adsorbed (Cojocaru, 2022) Cations are attracted to the negatively charged exterior surfaces of clay minerals and can also be pulled into the inside surfaces of expandable minerals, which changes their characteristics changing characteristics and structure. Some primary cations' replacement sequence in clay minerals locations in nature is the same as their abundance. (Ca²⁺>Mg²⁺>K⁺>Na⁺) (Aboudi Mana et al., 2017).

### Smectite Clay Minerals

Smectite, which comprises montmorillonite (MMT), Beidellite, Nontronite, Saponite, Hectorite, and Sauconite, is a 2:1 layer clay mineral that forms through the weathering of soils, rocks (often bentonite), or volcanic ash (Erdogan, 2015). Smectite has the chemical formula (Na,—Ca)0.3(Al, Mg)2Si4O10(OH)2. nH2O (Erdogan, 2015). When compared to other clay minerals, the Na montrimonlilite group has a larger swelling potential between the interlayers (Ahmed et al., 2019). The smectite group is distinguished by a large gap between units, which results in the creation of a weak bond and a high tendency to swell when it interacts with water. Water molecules are adsorbed on the interlayers as smectite clay minerals swell, increasing the basal spacing. As a result, when the smectite swells, its volume increases as much as two times than it was before. To minimize the swelling action of smectite clay, sodium and calcium ions are replaced with monovalent ions such as potassium (K⁺) and cationic ammonium ions (Gholami et al., 2018).

### Clay Swelling Mechanism

Many engineering difficulties, such as borehole instability, tunneling, and foundation stability, are known to be affected by swelling clays (Mohamed, 2000; Wangler & Scherer, 2008). In petroleum engineering clay swelling is mainly encountered during drilling operations. Reservoir clay swelling, which occurs in exposed rock formations, can have a negative impact on drilling operations and may lead to a significant rise in oil well construction costs. Borehole instability problems from clay swelling have been projected to cost more than $500 million per year in lost output, according to estimates (Bloys, 1994).

Minerals and argillaceous rocks have swelling as one of their most distinctive and essential characteristics. The inhibition of clay swelling is one of the key characteristics of the fluid which was considered during its formulation. An important factor determining clay swelling is the composition of clay solutions with which the clays interact. Several laboratory studies have shown that crystalline and osmotic swelling processes cause expansion (Reuland, 2022). In this process, monomolecular layers of water adsorb on the exterior and interlayer surfaces of the basal crystal. Molecular hydrogen bonds hold water molecules to exposed oxygen atoms on crystal surfaces. As shown in FIG. 2, Clay crystal structures are surrounded by water molecules, increasing in size as the structure's c-spacing increases (Karpiński & Szkodo, 2015a).

The crystalline water influences the exchangeable cations in two ways. First, many of the cations are hydrated, meaning they have water molecule shells around them (the exceptions being NH4⁺, K⁺, and Na⁺). Secondly, they bond to the crystal surface in competition with water molecules, causing the water structure to be disrupted. Na+ and Li+ are exceptions because they are lightly bonded and tend to diffuse away. (Hancock, 1978; Yuan et al., 2019) observed a discontinuity in the value of the interplanar spacing as the salt concentration was varied and defined the region as the critical salt concentration. Crystalline swelling occurs above the critical salt concentration.

The second form of swelling is called osmotic swelling. Because the concentration of cations between the layers is higher than in the bulk solution, osmotic swelling occurs. When the concentration of cations between unit layers in a clay mineral is higher than the concentration of cations in the surrounding water, water is osmotically pulled between the unit layers, increasing the c-spacing. Although no semipermeable membrane is involved, the process is osmotic since it is driven by an electrolyte concentration differential.

It is thought that clays that swell due to osmotic swelling are larger than those that swell due to surface hydration, but this may be true only for certain clays, like sodium montmorillonite. (Karpiński & Szkodo, 2015b). Those phenomena result in repulsive forces that separate clay flakes. When compared to crystalline swellings, Na and Ca montmorillonite (smectite) may exhibit a substantial increase in volume from 20% to 130% due to the repulsion of planes. Osmotic swelling can quickly lead to wellbore collapse if not mitigated in a drilling operation with an anti-swelling agent.

### Formation Damage

Formation damage is defined by (Civan 2015; Xu et al. 2016) as the deterioration of the permeability of petroleum-bearing formations due to a variety of unfavorable events. Physiochemical, chemical, biological, hydrodynamic, and thermal interactions of porous formations, particles, and fluids, as well as mechanical deformation of the formation under stress and fluid shear, may all contribute to it. Drilling, production, workover, and hydraulic fracturing activities all initiate these processes.

A clear distinction should be defined between formation damage and well-completion damage. Well-completion damage refers to the loss of well performance caused by other factors such as particulate matter deposition, fluid mobility reduction, and fluid flow conditions as a result of the limitations of specific completion techniques at and around the wellbore. (Al-Ansari et al., 2016; Dobson et al., 2000).

During drilling and completion operations the main mechanisms that cause formation damage during well completion are plugging of the pore throat and fluid incompatibility (D Carico et al., n.d.; Shan et al., 2014). The most common types of polymers used in preparing the completion fluids are CMC, Xanthan gum, and HEC (Alexander et al., 2019; Friedheim et al., 2012). These polymers are mostly mixed water. When the completion fluids are pumped into the reservoirs, the slick water can react with smectites in the rocks of the reservoir causing clay swelling. Hence the need to add clay inhibitors to the well completion fluids to avoid formation damage is undeniable. The introduction of foreign chemicals into the reservoir also affects the equilibrium state of the reservoir resulting in formation damage (Perez, 2020) (Amaclule et al., 1988; Bahrami, 2011; Civan, 1996) focused on experimental discoveries that improved knowledge of some of the several causes of formation damage. (Civan, 1996, 2015) provides the following list:
1. Foreign fluid invasions, such as water and compounds used to improve recovery, drilling mud invasion, and workover fluids;
2. Foreign particles invading and mobilizing indigenous particles, such as trash, sand, dirt particles, bacteria;
3. Wellbore pressures and temperatures, as well as well flow rates; and
4. Fluid properties and porous matrix properties.

Studies have been conducted to determine the best materials to minimize clay swelling with cay inhibitors (A. Patel, 2007; J. L. Suter, 2011; R. de C. Balaban, 2015). Temporary and permanent clay inhibitors are the two most common types that are commonly added to drilling fluids. Temporary clay inhibitors are compounds that prevent clays from swelling and migrating during drilling and completion but are quickly washed away by the formation's fluids thereafter. Simple inorganic cations like NaCl, KCl, ammonium chloride, and calcium chloride are the most popular temporary clay stabilizers. Treatment fluids with KCl solutions ranging from 2% to 4% by weight are usually indicated to reduce clay swelling and nonexpanding type clay migration. Electrolytes like NaCl and KCl have been utilized and shown to help avoid clay swelling (Berry et al., 2008). The implementation of these electrolytes does not always have a positive outcome, since it can result in flocculation of the clay minerals which adversely affects the properties of the drilling fluid resulting in a high fluid loss volume and flocculation of bentonite (Hassiba & Amani, 2012; Xiong & Devegowda, 2020).

TABLE 2
Disadvantages of Clay Inhibitors Used in the Petroleum Industry

| Clay Inhibitors | Disadvantages |
|---|---|
| Sodium Phosphate | Expensive(Davidson et al., n.d.) |
| Ammonium Chloride | Temporary stabilization effect and |
| | difficulties in handling(El-Monier |
| | et al., 2013; Patel & Swaco, 2009) |
| Cesium Formate | Expensive |
| Potassium Chloride | Can cause formation damage and |
| | environmentally hazardous |
| | (Almubarak et al., 2015) |
| Calcium Hydroxide | Chemical incompatibility with many |
| | formation waters (Himes et al., 1991) |
| Sodium Chloride | Breakdown in HTHP environments and |
| | can cause fines migration(Laux et al., 2008) |
| Tetramethylammonium | Expensive |
| Chloride | |

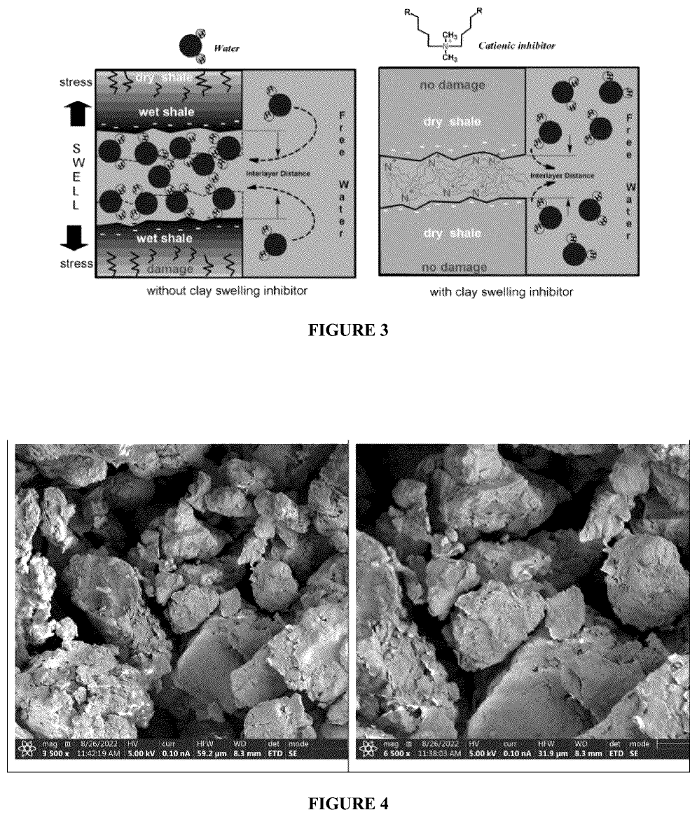

Cationic compounds with quaternary ammonium groups in their compositions are the most common organic additions employed as clay swelling inhibitors (Anderson et al., 2010; Karpiński & Szkodo, 2015b; Qu et al., 2009; Zhong et al., 2012). Between the siloxane layers, cationic organic molecules such as quaternary ammonium salts and diammonium methyl sulfate with varying alkyl chain lengths may lie flatly as a monolayer, reducing the swelling of bentonites (Hu et al., 2014). FIG. 3 shows a schematic representation of clay swelling inhibition mechanism: without cationic inhibitors' action (left side), and under the cationic inhibitors' action (right side) (Balaban et al., 2015).

### Examples

To provide a better understanding of the foregoing discussion, the following non-limiting examples are offered. Although the examples can be directed to specific embodiments, they are not to be viewed as limiting the invention in any specific respect.

In this experimental work, a great emphasis was placed on the effectiveness of commercial clay inhibitors such as sodium chloride (NaCl), potassium chloride (KCl), ammonium chloride (NH₄Cl), cesium formate (CHCsO₂,) and tetramethylammonium chloride (C₄H₁₂ClN). The results of experiments on the novel inhibitors using the linear swelling meter, capillary suction timer (CST), filtration time test, and dispersion test will be compared with the results of experiments using the commercial inhibitors. A linear swelling meter, a capillary suction timer (CST), filtration time test, dispersion test, energy dispersive spectroscopy (EDS), and scanning electronic microscope (SEM) were used for the experiments. Testing was conducted on the Na and Ca bentonite mixed with WBDM and commercial inhibitors for 3%, 4%, and 5% concentrations. Similar tests were conducted using the 3%, 4%, and 5% concentrations of novel inhibitors. To further check the inhibition performance of the best performing of these inhibitors, cutting dispersion test and linear swelling meter test was conducted on the Pierre Type II shale samples to analyze the performance of these novel inhibitors on the reactive shale samples. Its inhibition performance is compared to that of commercial clay inhibitors.

### Bentonite (Physical and Chemical) Characterization

A Wyoming Na bentonite was acquired from the drilling fluids lab at the University of Louisiana Lafayette for the experimentation. The Ca-Bentonite was also acquired from the Euclids LLC.

A dehydration curve was plotted for the Ca and Na bentonite samples. The idea was to study the amount of water lost by the calcium and sodium bentonite samples when increasing temperature. Firstly, an FTIR test is done on the bentonite samples, the samples weighed and dried in an oven for 24 hours at 50 degrees Celsius. The temperature is increased to 100, 150, 200, and 250 degrees Celsius every 24 hours. The weight of the samples are measured every 24 hours before the temperature is increased. Lastly, An FTIR test is done on the test to check if the samples are completely dried. The percentage of water loss at every temperature is calculated using the formulae below. A dehydration curve then is plotted and analyzed. An equation for the dehydration curve can be stated as follows:

Ww−Wd/Ww*100%,
where Ww is wet weight of bentonite and Wd is dry weight of bentonite after 24 hours.

### X-Ray Diffraction Studies (XRD)

Mineralogical characterization of bulk samples was preceded by crushing representative samples to a homogeneous fine powder using a ball mill. Prepared samples were then loaded into the XRD machine. The mineralogical data were generated using Rigaku MiniFlex 600 X-ray diffractometer (XRD) instrument. Scans were run over the range of 5°˜85° with a scanning rate of 5° per minute. Phase identification and pattern matching of the diffraction patterns were completed using PDXL proprietary software by Rigaku and the International Center for Diffraction Data (ICDD) database. Whole Profile Pattern Fitting (WPPF) refinement calculations were applied using the same software to determine the optimal structural parameters of phases present and to quantify mineral proportions. The XRD test was conducted at the geology department at the university of Louisiana, Lafayette.

To further analyze the Na bentonite and Ca bentonite used. Samples were sent out to Core lab reservoir optimization company in Brossard, Louisiana for further study. The procedure of the test in listed below:

Samples submitted for whole-rock and clay-fraction XRD mineral analyses are first disaggregated in a mortar and pestle. Approximately five grams of each sample are transferred to reagent grade isopropyl alcohol and ground using a McCrone micronizing mill with a five minute grind time. The resultant powders are dried, disaggregated, and back-loaded into aluminum sample holders to produce random whole-rock mounts. A separate split of each hand-ground sample is dispersed in a dilute sodium phosphate solution using a sonic probe. The suspensions are then centrifugally size-fractionated to isolate clay-size (<4 micron ESD) materials for a separate clay-fraction mount. The suspensions are then vacuum-deposited on silver membrane filters to produce oriented clay mineral aggregates. Membrane mounts are attached to stainless steel slugs and exposed to ethylene glycol vapor for a minimum of 24 hours.

### Analytical Procedures

XRD analyses of the samples are performed utilizing a Scintag Pad X or Siemens D5000 automated powder diffractometer equipped with a copper source (40 k V, 40 mA) and a solid state or silicon drift detector. The whole rock samples are analyzed over an angular range of 2-70 degrees 2-theta at a scan rate of one degree/minute and a step size of 0.02 degrees. The glycol-solvated clay-fraction mounts are analyzed over an angular range of 2-40 degrees 2-theta at a scan rate of 1.5 degrees/minute and a step size of 0.03 degrees. Phase identification is done utilizing the computer-assisted search/match algorithm in MDI Jade 9.3 XRD software and the International Centre for Diffraction Data (ICDD) database for minerals and inorganic compounds.

Semi-quantitative determinations of whole-rock and phyllosilicate mineral amounts are done utilizing integrated peak areas (derived from peak-decomposition/profile-fitting methods) and empirical reference intensity ratio (RIR) factors determined specifically for the diffractometer used in data collection. The total clay mineral (including mica) abundance of each sample is determined from the whole-rock XRD patterns using combined {001} and {hkl} clay mineral reflections and suitable empirical RIR factors.

XRD patterns from glycol-solvated clay-fraction samples are analyzed using techniques similar to those described above. Determinations of mixed-layer clay ordering and expandability are done by comparing experimental diffraction data from the glycol-solvated clay mineral aggregates with a proprietary database of simulated one dimensional diffraction profiles generated using the program NEWMOD written by R. C. Reynolds.

### Fourier Transform Infrared (FTIR) Spectroscopy

FTIR Spectrum analyses measure the way infrared wavelengths are absorbed by materials in the infrared range. A material's molecular composition and structure are determined by its ability to absorb infrared light at various wavelengths. A database containing reference spectra is searched to identify unknown materials from their IR spectrum. FTIR materials characterization can be used to quantify materials as long as there is a standard curve of known concentrations of the component of interest.

When IR radiation is passed through a sample, some radiation is absorbed by the sample and some passes through (is transmitted). The resulting signal at the detector is a spectrum representing a molecular ‘fingerprint’ of the sample. Decoding the signal is accomplished through the application of a mathematical technique called Fourier transformation. As a result, a mapping is created based on the spectral information produced by the computer. A spectrum is generated from the resulting graph, which is compared against a reference library for identification. The FTIR was done on the Ca and Na bentonite during the dehydration analysis on the test samples.

Scanning Electronic Microscope (SEM) And Energy Dispersive Spectroscopy (EDS) The characterization of pores and embedded minerals in clay samples have been greatly aided by scanning electron microscopy (SEM) examination. SEM images are commonly used to determine the orientation, compaction, and texture of various clay surfaces. The majority of clay inhibition SEM examination findings look into the phenomena of clay blockage and thin layer creation. Inhibitors enclose the pores, restricting the flow of drilling fluids into the pores, as in the case of water-based drilling fluids (WBDFs) and polymeric inhibition.

An energy dispersive spectroscopy was on the Ca and Na bentonite to check the elemental composition of the bentonites used for the experiment. The results from the EDS will show the quantitative amount of each of the minerals composed in the Ca and bentonite. The results from the EDS and the XRD can be used to know the percentage of the smectite minerals composed in the bentonites.

### Inhibitor Testing

(Stephens et al., n.d.) did an extensive work on the types of testing to be done when analyzing swelling. (Buranaj Hoxha, 2016; van Oort, 2018) did an evaluation of these tests, how these tests procedures affects their results.

### Drilling Fluid

Water-based drilling fluid was prepared by Halliburton at Broussard in Louisiana, USA. The drilling fluid did not contain any clay inhibitor or bentonite. The properties and components of the drilling fluid are listed in Table 3.

TABLE 3
The components of the drilling fluid
prepared by Halliburton, Broussard, USA

| Formulation | | Mix 1 | | |
|---|---|---|---|---|
| Density | 1.04 | | | |
| BARAZAN ® D PLUS | 2 lb/bbl | | | |
| (US-LFT) | | | | |
| Broussard Tap Water | 0.986 | | | |
| (US-LFT) | lb/bbl | | | |
| BAROID ® (Barite) | 15.553 | | | |
| (US-LFT) | lb/bbl | | | |
| Density | | Mix#1 | | |
| Temperature, C. | 22.5 | | | |
| Temperature, F. | 72.5 | | | |
| Density [SG] | 1.03 | | | |
| Density [ppg] | 8.58 | | | |
| Rheology | | | | |
| Temperature | | 21.1 | 48.9 | 65.6 |
| Temperature | | 70 | 120 | 150 |
| 600 rpm | | 42 | 38 | 36 |
| 300 rpm | | 35 | 32 | 31 |
| 200 rpm | | 31 | 30 | 28 |
| 100 rpm | | 27 | 26 | 24 |
| 6 rpm | | 18 | 16 | 14 |
| 3 rpm | | 16 | 15 | 13 |
| 10 s Gel [lb/100 ft2] | | 19 | 17 | 15 |
| 10 min Gel [lb/100 ft2] | | 22 | 21 | 18 |
| 30 min gel [lb/100 ft2] | | 23 | 21 | 18 |
| PV [cp] | | 7 | 6 | 5 |
| YP [lb/100 ft2] | | 28 | 26 | 26 |
| YP[Pa] | | 13.4 | 12.5 | 12.5 |
| LSRYP[lb/100 ft2] | | 14 | 14 | 12 |

| | |
|---|---|
| pH | Mix #1-Ageing#1 |

| | |
|---|---|
| pH | 8.06 |
| Temperature, F. | 72.5 |
| Temperature, C. | 22.5 |

### Capillary Suction Timer

The capillary Suction Time principle was developed at the water pollution laboratory in England to assess the filterability of sewage sludge and to evaluate the effect of pre-treatment chemicals and process conditions of sewage treatment. The CST is used by the petroleum industry to characterize bentonites and to optimize the electrolyte content in drilling, stimulation, and workover fluids to reduce the impact on reservoir formations. The CST tests are simple and quick to perform, and they offer relative information regarding an additive's clay inhibition properties (Berry et al., 2008). Many researchers have described the CST theory and practice, as well as the tests' limitations. When evaluating various shale inhibitors, the capillary suction test (CST) is mostly utilized. The analysis is conducted with equipment that measures how long a clay slurry takes to flow through the filter medium. A clay dispersion (5 ml) containing a specific inhibitor is first placed inside a cylinder. A timer and two electrodes at 0.5 and 1 cm positions are linked to the cylinder containing the filter paper with a predetermined thickness. The electrodes records how long it takes for the clay slurry to flow through the free water from one end to the other. (Muhammed et al., 2021). The method is rapid and easy to use. A good clay inhibitor will prevent the clay material from swelling, resulting in more free water, a more permeable filter cake, and a shorter CST time. Less effective clay stabilizers will result in clay swelling that absorbs free water, creating a relatively impermeable filter cake and a longer CST time interval. Standardized sample preparation and test protocols can produce consistent findings in the evaluation of many clay stabilizers. The major limitation of the CST is that it sometimes tends to overestimate the sensitivity of test materials or formations to treatment fluids.

### Inhibitors Used for Experimentation and CST Experimentation Procedure

An important factor used in the preparation is the concentration and the proportion of the Ca and Na bentonite used in the preparation of the drilling fluid. The types of inhibitors and their concentration used is listed in Table 4.

TABLE 4
List of Commercial Clay Inhibitors and their
Concentration Used in the mixtures for the CST Test

| | | CONCEN- |
|---|---|---|
| INHIBITOR | SYMBOL | TRATION (%) |
| Potassium chloride | KCl | 3, 4, 5 |
| Ammonium chloride | NH₄Cl | 3, 4, 5 |
| Sodium chloride | NaCl | 3, 4, 5 |
| Tetramethylammonium Chloride | Me4N⁺Cl⁻ | 3, 4, 5 |
| Cesium Formate | CHCsO₂ | 3, 4, 5 |

TABLE 5
List of Inventive clay Swelling
Inhibitors and Their Concentration

| | | CONCEN- |
|---|---|---|
| INHIBITOR | SYMBOL | TRATION (%) |
| F1CHN-70 | N/A | 3, 4, 5 |
| F2CHN-70 | N/A | 3, 4, 5 |
| F3CHN-70 | N/A | 3, 4, 5 |
| F4CHN-70 | N/A | 3, 4, 5 |
| INCH | N/A | 3, 4, 5 |

The procedure for measuring the CST is as follows: The Na and Ca bentonites were dried for 24 hrs in an oven to ensure that it is completely dried; 30 ml of drilling fluid was measured using the volumetric flask; Weigh 3.5 g of either Na or Ca bentonite to be added to the 30 ml of the measured drilling fluid; Measure the required amount of concentration 3% (0.9 grams),4% (1.2 grams), and 5% (1.5 grams) to be used for the experiment; Put the drilling fluid into a beaker and slowly add the clay inhibitor and allow the mixture to mix for 5 minutes on the magnetic mixing machine allowing the Na or Ca bentonite to be well hydrated by the water; Set up the CST machine and ensure that the filter paper is not wet, and the electrodes are dry; A syringe is used to take 5 cc of the mixture and the amount of time it takes for the machine to beep is recorded in seconds; The experiment is repeated three times for each clay inhibitor for every concentration; and The experiment is also conducted following the procedure above without the addition of inhibitors to serve as a baseline for the experimentation.

### Filtration Time Test

A filtration time test experiment was conducted for The Na and Ca bentonite 5%, 4%, and 3% concentrate of the commercial inhibitors and novel inhibitors produced at the University of Louisiana, Lafayette. The amount of filtrates that filters through the Whatman #2 paper shows if the clay inhibitor is inhibiting the clay from swelling. The procedure for the experimentation is as follows: 50 ml of water is measured and mixed with 2.5 g of Ca and Na bentonite. percentage 3% (1.575 grams),4% (2.1 gram) and 5% (2.625 grams) concentration to be used; Put the water into a beaker and slowly add the inhibitor while the mixture is being stirred on a magnetic stirring machine allowing the Na or Ca bentonite to be completely hydrate; Add the clay inhibitor to the mixture slowly and allow the mixture to mix for about 15 minutes to ensure the bentonite is completely hydrated; Set up the Filtration time test apparatus and slowly pour the mixture into Whatman #2 filter paper; Measure the amount of liquid that has been filtered through the filter paper after 2.5, 5, 10, 15, 20, 25, and 30 minutes. The experiment is also conducted following the procedure above without the addition of inhibitors to serve as a baseline for the experimentation

### Linear Swelling Test

In this study the linear swelling of the Ca and Na bentonite was tested using the linear swell tester at the Baker Hughes Central laboratories in Houston, Texas. The clay wafers were exposed to different drilling muds prepared by mixing various concentrations of KCl, F2CHN-70, F3CHN-70 and F4CHN-70.

Using a Fann Linear Swell Meter, a linear swelling test was conducted. Under both static and dynamic conditions, at high temperatures up to 500 F and high pressures of roughly 2000 psi, the equipment can assess the linear swelling of the formation. To produce the wafers, a Fann Dual Core/Wafer Compactor was used. The dried 20 grams of bentonite samples were put under 10,000 psi pressure for 2 hours in the Wafer Compactor chambers. The LST experiment was run for 16 hours at 30° C. at atmospheric pressure.

### Cuttings Dispersion Tests

During drilling and completion fluids, cutting dispersion tests are performed to determine additive effectiveness at maintaining cutting integrity and minimizing shale section interaction. This Test is mostly suitable for formations with high smectite content in them. This experiment was done on Pierre type II shale samples provided by Baker Hughes.

20 grams of the cutting pieces (−6 mesh and +20 mesh sieves) were exposed to 3% and 5% concentrations of 350 ml of the best performing (novel) inhibitors from the linear swelling meter test and KCl. The Fluids containing Shale samples cuttings were rolled at 105° C. for 16 hours in a fluid to simulate conditions downhole. The samples are then sieved through a number 10 sieve and the retaining are dried at 105° C. for 16 hours. The percentage recovery of the shale can be stated as follows:

$$\frac{Retained weight on the ( - 6 mesh and + 20 mesh sieves )}{Total weight used for the experimentation} \times 100 \%$$

One major factor that affect the test results is the Fluid rheology characteristics and the amount of agitation during the rolling phase.

### Rheological Properties Measurement

Rheological properties test was conducted on Zimbabwe mud prepared by Baker Hughes, Houston Texas and different concentration of inhibitors were added to it to check the changes that occur in the rheological properties of the fluid. The rheometer was used to determine PV, YP, 10-s gel strength (10-s GS), and 10-min gel strength (10-min GS) properties. We determined the rheological properties and lubricity of the material at ambient temperatures. PV and YP can be stated as follows:

PV=Ø600−Ø300; and

YP=Ø300−PV,
where Ø600 is dial reading at 600 RPM and Ø300 dial reading at 600 RPM.

### Results and Discussion

### Dehydration Analysis on Ca and Na Bentonite

While both Na and Ca bentonites lost a small amount of water after 24 hours of drying at 50° C., they lost a greater amount of water when heated to 150° C. for 24 hours and to 250° C. for 24 hours. The idea was to know the temperature to dry the bentonites to ensure that the bentonites are completely without damaging the mineralogical properties ofd the bentonites. (Borchardt & Daniels, 1957), did extensive research on bentonite and concluded that bentonite minerals are destroyed at a temperature of 905° C. The presence of water in the bentonite samples can also affect the results of some experimentations such as CST and filtration time tests. After drying, infrared radiation tests (FTIR) were performed on the dried bentonite samples to confirm that the bentonite samples used in the experiment (Filtration, Time test and CST) were dry.

The results from the Ca and Na bentonite before drying shows a presence of water in the samples. The transmittance % of 3700 to 2900 show the presence of water in the sample. If there is a high amount of water in the bentonite sample used in the experimentation it can affect the results of the CST and filtration time test. On the other hand, if the samples are too dry, it affects the linear swelling meter test through osmosis (Dimataris, 2017). Using the Aqua-lab drew activity meter the water activity of the type 2 shale sample used for the dispersion test was measured.

### Mineralogical Composition of the Ca and Na Bentonite

An XRD test was conducted on the Ca and Na bentonite as used for the experimentation to determine the mineralogical composition for the clays using the Rigaku MiniFlex 600 X-ray diffractometer (XRD) instrument. The results from the XRD showed that the Na bentonite contained quartz and montmorillonite as the major constituent mineral. The presence of minerals such as Heulandite Sepiolite and Palygorskite which are smectite minerals also makes the minerals to swell. These minerals are phyllosilicate minerals that causes cationic exchanges in their structure when they react with water (Norrish, 1954). A Sepiolite or a Palygorskite is a mineral that forms as an alternative to smectite under mild conditions. In montmorillonite, a negatively charged octahedral layer of silica, aluminum, and oxygen is sandwiched between two tetrahedral layers (TOT sheet) and positive counter cations in the interlayer space. As water enters the interlayer space, the interlayer cations become hydrated, which causes the clay to swell (Mahmoud ct al., 2018)

The Ca bentonite and Na bentonite were similar, according to the XRD results. The only difference in the composition was the high amount of the quartz mineral and the lower amount of the smectite mineral (Sepiolite, Heulandite, Palygorskite) in the Ca bentonite. As explained by (Gao et al., 2022) the smectite minerals causes the swelling of the clay and is higher abundance in clay will aid the swelling. Also, there was a high presence of the illite mineral in the Ca bentonite.

A further XRD analysis was done at Core Lab, where UL 221 is Ca bentonite UL22 is the Na bentonite. The results showed the Ca bentonite had a smectite content of 81.8% and that of the Na bentonite as 63.3%. There was not much difference between the results from Corelab and the XRD characterization done in the university of Louisiana Lafayette laboratories.

### Elemental Composition

In order to determine the elemental composition of the bentonites, the bentonite samples were coated with layers of carbon and the energy-dispersive spectrometers was done to determine the elemental composition. The results are shown in Table 6.

TABLE 6
EDS Quantitative Measure of the Elemental
Composition of Na Bentonite

| Element | Weight % | Atom % |
|---|---|---|
| C | 6.65 | 10.78 |
| O | 48.57 | 59.14 |
| Na | 1.67 | 1.41 |
| Mg | 1.01 | 0.81 |
| Al | 8.04 | 5.80 |
| Si | 28.68 | 19.89 |
| S | 0.39 | 0.24 |
| K | 0.43 | 0.21 |
| Ca | 0.91 | 0.44 |
| Fe | 3.66 | 1.28 |
| Total | 100.00 | 100.00 |

The results show a high peak for Silicon and oxygen with each having an atom % of 59.18 and 19.89 respectively. These two elements are the common minerals in phyllosilicate minerals, and it forms the tetrahedral structure of the clay. The results show that there is iron, aluminum and magnesium with each having an atomic % of 1.28, 5.80, 0.81 respectively.

All the minerals are present in this test, which is consistent with (Brigatti et al., 2013) explanation that when tetrahedral and octahedral sheets are joined to form a layer, either a neutral or negatively charged structure will result. The results are shown in Table 7.

TABLE 7
EDS Quantitative Measure of the Elemental
Composition of Ca Bentonite

| Element | Weight % | Atom % |
|---|---|---|
| C | 6.08 | 9.86 |
| O | 49.73 | 60.61 |
| Na | 1.66 | 1.41 |
| Mg | 1.97 | 1.58 |
| Al | 10.04 | 7.25 |
| Si | 24.01 | 16.67 |
| S | 0.27 | 0.16 |
| K | 0.33 | 0.16 |
| Ca | 1.58 | 0.77 |
| Fe | 4.34 | 1.51 |
| Total | 100.00 | 100.00 |

The results for the Ca bentonite was similar to the Na bentonite however that was a higher atomic % of the Calcium in the structure than they were in the Na bentonite. This higher presence of the Ca explains why Ca bentonites are not a higher absorbent of when it comes into contact with water into its crystal. (Sawhney, 1972) explained this phenomenon using the ionic radios and cation hydration energy. Na has an ionic radius of 0.98 and hydration energy of 406 kJmol⁻¹ Whiles Ca has a radius of 0.99 and hydration energy of 1577 406 kJmol⁻¹. The higher hydration energy of the Calcium does not allow it to be an easily absorbent of the water to swell because the hydrogen bonding is stronger than the hydrogen bonding of sodium bentonites.

### Scanning Electronic Microscope

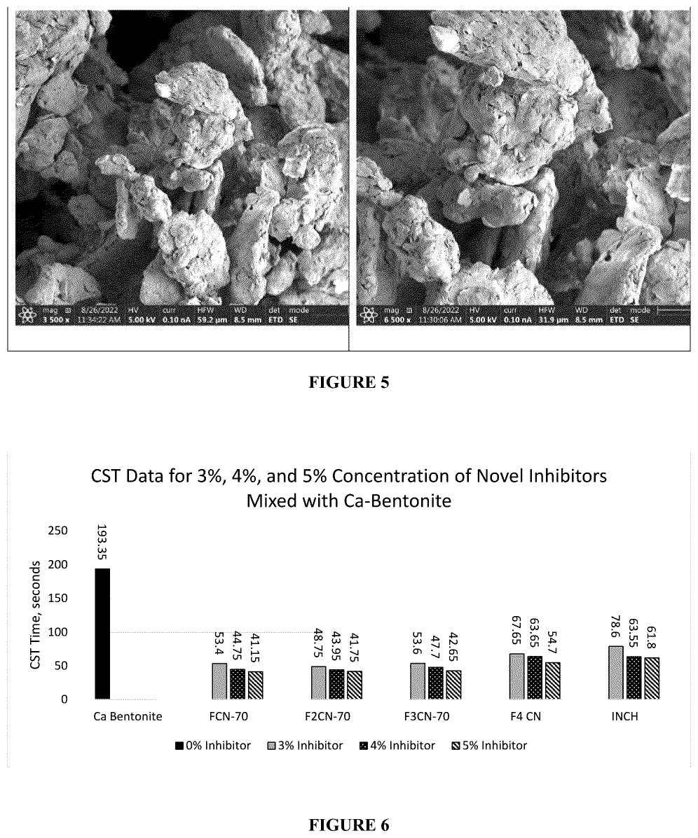

The surface properties and morphology of the Ca and Na bentonites under investigation were examined using SEM methods. The samples were put on the stub, which had gold conducting layers sputter-coated over it. The Ca and Na bentonites surfaces was examined at 3500 and 6500 magnifications. The SEM of sodium bentonites (FIG. 4) shows that the Na bentonites are looser while the Ca bentonites (FIG. 5) are more compacted. Ca bentonites have perfectly oriented platelets as compared to Na bentonites. The spaces between the particles in the Ca bentonite are also wider than those in the Na bentonite, as shown in FIG. 4 and FIG. 5. This explains why the sodium bentonites were good adsorbent of water than the Calcium bentonite.

### Fluid Properties

Fluid parameters were measured and recorded, including specific gravity, pH, and physical observations. Water activity was measured using an Aqua-lab 4Te meter and the pH of the fluids were measured using Star A111 pH Meter Unbound water vapor pressures are measured using water activity meters (AW) to determine microbiological deterioration, chemical stability, and physical stability (Hoxha et al., n.d.). From the table, water activity decreased as concentration increased for all the inhibitors used for the experimentation. Fluid observations indicated that only the F4CHN-70 solutions precipitated after being mixed with tap water. pH values for 3% and 5% F4CHN-70 were 7.4 and 6.8, respectively. A decrease in pH is observed for the F4CHN-70 fluid with an increase in concentration, whereas an increase in pH is observed for the F2CHN-70 and F3CHN-70 fluids with an increase in concentration. Compared to F4CHN-70, the solutions of F2CHN-70 and F3CHN-70 were more base-like (pH>7) also the F3CHN-70 and F2CHN-70 increased with concentration. Both 3% and 5% concentrations of the fluids showed positive results in terms of their water activity. The results are shown in Table 8.

TABLE 8
Properties of Fluids Used for the Linear Swelling
Meter Test and Clay Dispersion Test
Fluid Properties

| | Specific | | | |
|---|---|---|---|---|
| | gravity | pH | Observation | Aw |
| 5% wt KCl | | 7.7 | | 0.98 |
| 3% F2CHN-70 | 1.626 | 8.7 | | 1 |
| 3% F3CHN-70 | 1.74 | 9.4 | | 1 |
| 3% F4CHN-70 | — | 7 | precipitation | 1 |
| 5% F2CHN-70 | 1.626 | 8.9 | | 0.995 |
| 5% F3CHN-70 | 1.74 | 9.6 | | 0.998 |
| 5% F4CHN-70 | — | 6.8 | precipitation | 0.996 |

### Characterization of Pierre Type II Shale Samples

A linear swelling meter and Clay dispersion test was conducted on Pierre Type II shale samples provided by Baker Hughes drilling and completion fluids laboratories at Houston, Texas.

The Pierre Type II shales are very reactive and contains 21% quartz and 55% smectite. Testing swelling effects complications is challenging due to the high reactive clay component (Hoxha et al., n.d.). Properties such as water content and water activity was measured to be 0.96 and 16% respectively.

TABLE 9
Mineralogy of reactive shale, Pierre Type II

| Minerology | Percent Compositions |
|---|---|
| Quartz | 14 |
| Calcite | tr |
| Pyrite | tr |
| Dolomite | tr |
| Illite | 44 |
| *Mixed Layer | 41 |
| Kaolinite | — |
| Chlorite | 1 |

*>95% Expandable Layers in Mixed Layer

TABLE 10
Re-constituted/re-hydrated
shale and bentonite sample

| | PT II |
|---|---|
| Wi | 10 |
| Wf | 8.4 |
| % Water Content | 16 |
| Content Factor | 0.84 |
| Aw | 0.96 |

### Inhibitor Performance Evaluation

### Capillary Suction Timer Test

For the clay inhibitors produced 3%, 4%, and 5% concentrations of F4CHN-70 gave the best results when tested on the Na bentonite clay. The CST time decreased from 3363.6 without inhibitor to 38.6 seconds at 3% concentration to 30.6 seconds at 4% concentration and 25.3 seconds at 5% concentration of F4CHN-70, demonstrating that the clay inhibitor inhibited the Na bentonite from absorbing water. The inhibition performance of F3CHN-70 was similar to the F4CHN-70 at the 3%, 4% and 5 percent concentration. Though the F2CN70 and INCH inhibition performances was not as good as the F4CHN-70 and F3CHN-70, they both performed better than the KCl. The average inhibition times for these inhibitors were 170 seconds for 3% concentration which was 351.1 seconds lesser than the inhibition time of KCl. The F1CHN-70 showed the least inhibition performance with the produced clay inhibitors. It was observed that for good inhibition performance of the F1CHN-70 higher concentrations has to be used.

The CST time was lowered with potassium chloride from 193.4 without the inhibitor to 34.2 seconds for 3 but it was significantly reduced with the 4% and 5% concentrations, respectively, by 29.2 seconds and 23.6 seconds. There was no significant difference in the time for the concentrations for the commercial clay inhibitors. NaCl produced the least reaction time for the commercial inhibitors however the results was similar to the Tetramethylammonium Chloride.

Compared to the Na bentonite, the swelling rate of the Ca bentonite was lower the inhibition time without the inhibitors was lower in the Ca bentonite. The Ca bentonite produced a time of 193.4 seconds whiles the Na bentonite produced a time of 3363.6. This indicates that the Na bentonites has a high swelling ability than the Ca bentonite. This phenomenon can be explained using the ionic radius and hydration energy of the of the Ca and Na elements.

The Na bentonite has 0.98 ionic radius, and 408 hydration energy whiles Ca has 0.99 ionic radius and 1577 hydration energy. Since the hydration energy of Na is low it makes is very volatile than Ca bentonite.

### Filtration Time Test

An experiment was conducted to compare the results of the Filtration Time test with the CST test. A filtration time test determines the inhibitor's effectiveness by the amount of water filtered through Whatman paper number 2.

In 5 minutes, a mixture of Na bentonite with water produced a filtrate volume of 15 ml of the 50 ml of water that was used for the experiment. This demonstrates the strong absorptive capacity if the Na bentonite clay. FIG. 6 shows that Ca bentonite has low absorptivity when reacting with water compared to the Na bentonite. However, the filtering rate for the commercial inhibitors was greater in the calcium bentonite than in the sodium bentonite, with KCl producing the best outcomes for both Ca and Na bentonites. About 90% of the water used had filtered through the Whatman #2 paper in 5 minutes, this shows that the Na bentonite's ability to absorb more water into its structure was inhibited by the KCl. The least performing of all the commercial inhibitors used for the experimentation was the NaCl. The inhibition performance was low in the Na bentonite than the Ca bentonite. The tetramethylene ammonium chloride and the cesium formate showed a similar result for the Na bentonite and Ca bentonite.

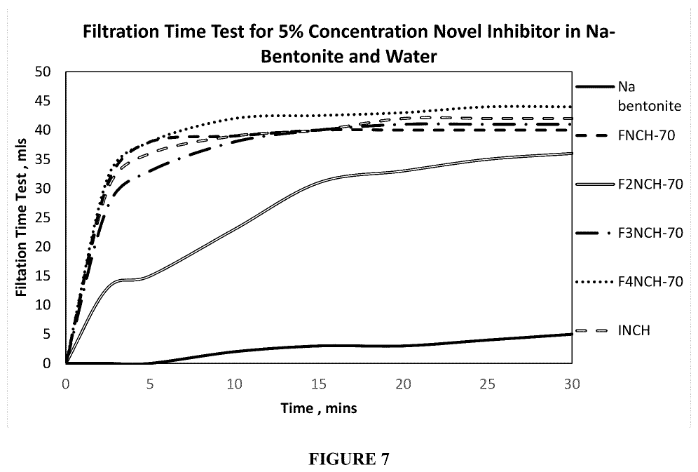

FIG. 7 shows the filtration time test results for 5% inhibitors mixed with Na bentonite and water. The results of the 5% concentration of the inhibitors shows the F4CHN-70 performing better inhibition than the other inhibitors. 38 ml of the 50 ml of water used for the experiment had filtered through the Whatman #2 paper in five minutes compared to the blank (Na bentonite mixed with water without inhibitor) that had only 5 ml of the 50 ml of water filtered through it after 5 minutes. The F4CHN-70 filtered 43 ml of the 50 ml water within the experimentation time. This is a good indication that the inhibitor is preventing the clay from absorbing water hence preventing swelling. F2CHN-70 gave the poorest inhibition compared to the other inhibitors. Only 15 ml of the 50 ml of water used was filtered through the filter paper in five minutes. The Na bentonite retained 15 ml of water used during the experimentation. This clearly shows that the was a poor inhibition from the F2CHN-70.

FIG. 8 shows the filtration time test results for 5% inhibitor mixed with Ca bentonite and water. The results of the 5% concentration of the inhibitors shows the F4CHN-70 performing better inhibition than the other inhibitors. Compared to the Na bentonite results more water was filtered through the filter paper in five minutes for the Ca bentonites for all inhibitors. 45 ml of the 50 ml of water used for the experiment filtered through the Whatman #2 paper in five minutes compared to the blank (Ca bentonite mixed with water without inhibitor) that had only 7 ml of the 50 ml of water filtered through it after 5 minutes. This confirms the inhibition performance of the F2CHN-70 in the Na bentonite and also in the CST. F2CHN-70 gave the poorest inhibition compared to the other inhibitors. Only 15 ml of the 50 ml of water used was filtered through the filter paper in five minutes. The Na bentonite retained 15 ml of water used during the experimentation. This clearly shows that the was a poor inhibition from the F2CHN-70.

### Linear Swelling Meter Test

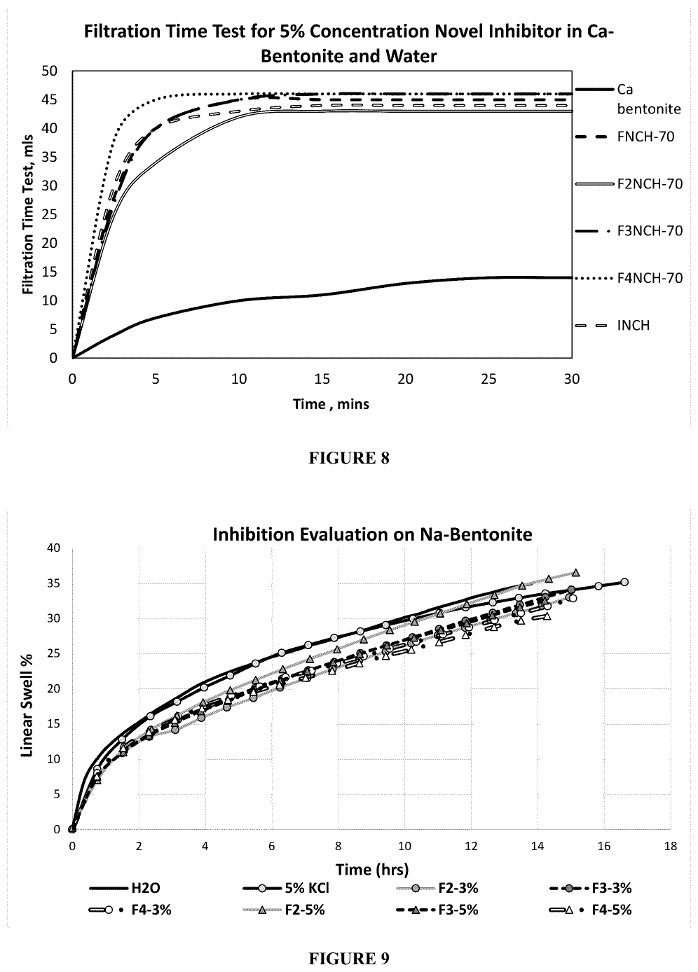

FIG. 9 shows the linear swelling test for 3% and 5% concentration mixed with Na bentonite. From this experimentation it was observed that F4CHN-70 produced the strongest inhibition performance. Water which was used as a baseline for the experimentation made the Na bentonite sample swell by 40% after 14 hours. The KCl used as the bench mark to compare the inhibitors with also caused a high swelling of the bentonite. The 3% concentration had the least inhibition performance with the swelling rate after 14 hours been the same as the water without inhibitor. This phenomenon was explained by (Murtaza et al., 2020) as Silicate inhibits by physiochemical means hence When the pH is reduced, silicates adsorb on the layers of clays and form a thin layer, which prevents water from invading the layers. Meanwhile, K ions attach to the negative ions of the clay layers as they replace the cations. The inhibition performance of the F2CHN-70 and the F3-70 for 3% and 5% concentrations were similar. They both showed a good inhibition performance than the KCl.

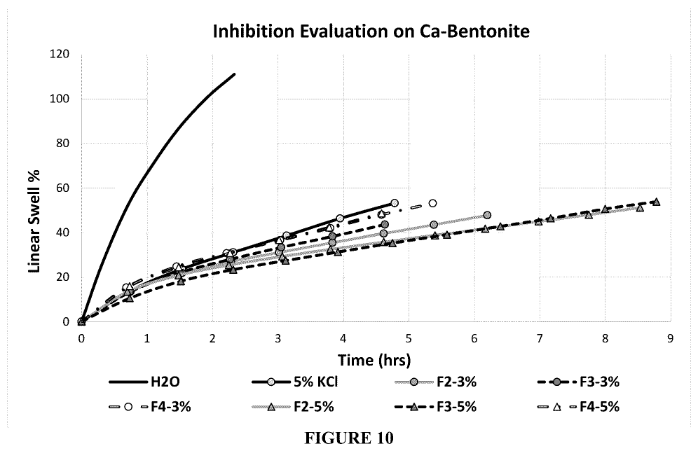

FIG. 10 shows the linear swelling test Ca bentonite samples. The results shows a high swelling ability of the CA bentonite without inhibitors after 2 hours. The sample size increased more than 100%. The KCl reduced the swelling from 120 percent to 55 percent after five hours. The F4CHN-70 showed the least performance with the inhibitors. Its inhibition time was closer to that of the KCl. The F3CN70 showed the best inhibition performance compared to the other inhibitors. The inhibition was reduced from 120% to 50 percent after 9 hours. This can be seen in the physical appearance of the wafer samples used. The wafer samples show there was not much increase in the size compared to the Ca bentonite with water (blank). The low inhibition percentage of the inhibitors in Ca bentonite compared to the Na bentonite is due to the strong bond between Ca and hydrogen when the Ca bentonite reacts with water. These strong bonds are difficult to be broken by the inhibitors, that is, the lack of hydration of Ca bentoniteis due to the hydrogen bonding. The and Calcium (Ca2+) cation has been attached to the chemical structure of bentonite therefore making adsorption of water weak.

### Pierre Type II Shale Samples

### Cutting Dispersion Test

For the accretion and cutting disintegration test higher percentages of the cuttings recovered from the 10mesh (2 mm) sieve relates to a more inhibitive fluid. The industry mostly accepts 85% of accretion as the standard for clay inhibitors. F4CHN-70 gave the best results with the shale cuttings. It retained an average of 95% of the cutting on the 10mesh (2 mm) sieve for 3% and 5% concentration compared to KCl that retained 56% of the cutting and water that retained 43% of the cutting after the experimentation. This shows that when used in the mud it will dissolve the shale cutting used. When the shale cutting is dissolved in the water based mud it can affect the yield point of the mud which will then effect of the ability of the drilling mud to lift or remove the cuttings out of the annulus. Also, if this cutting is not removed properly, it can stuck the drill pipe and the oil well can be lost.

The water used in the experimentation was used as the baseline and the KCl was used as a comparison. Results for F2CHN-70 and F3CHN-70 for 3% concentration shows 88.86% and 88.82%, respectively. The results are shown in Table 11.

TABLE 11
Accretion Test Results of Inhibitors Mixed
with Pierre Type II Shale Samples

| | | 5% | 3% | 3% | 3% | 5% | 5% | 5% |
|---|---|---|---|---|---|---|---|---|
| | H₂O | KCI | F2 | F3 | F4 | F2 | F3 | F4 |
| Volume of test fluid | 350 | 350 | 350 | 350 | 350 | 350 | 350 | 350 |
| W1 - intial (g) | 20 | 20 | 20.03 | 20 | 21.02 | 20 | 20 | 20 |
| W2 - ″wet″ - total (g) | 13 | 15.8 | 22 | 26.6 | 24.5 | 22.47 | 26.7 | 18.56 |
| W3- ″dry″- total (g) | 7.8 | 10.2 | 16.05 | 16.02 | 18 | 16.29 | 14.65 | 16.44 |
| % Hydration | 67% | 55% | 37% | 66% | 36% | 38% | 82% | 13% |
| % Recovery Total | 43.25 | 56.55 | 88.86 | 88.82 | 94.96 | 90.32 | 81.23 | 91.15 |
| (above 0.5 mm) | | | | | | | | |

FIG. 11 shows the Accretion Cutting test results for inhibitors mixed with Pierre Type II shale samples.

### Linear Swelling Meter Test on Pierre Type II

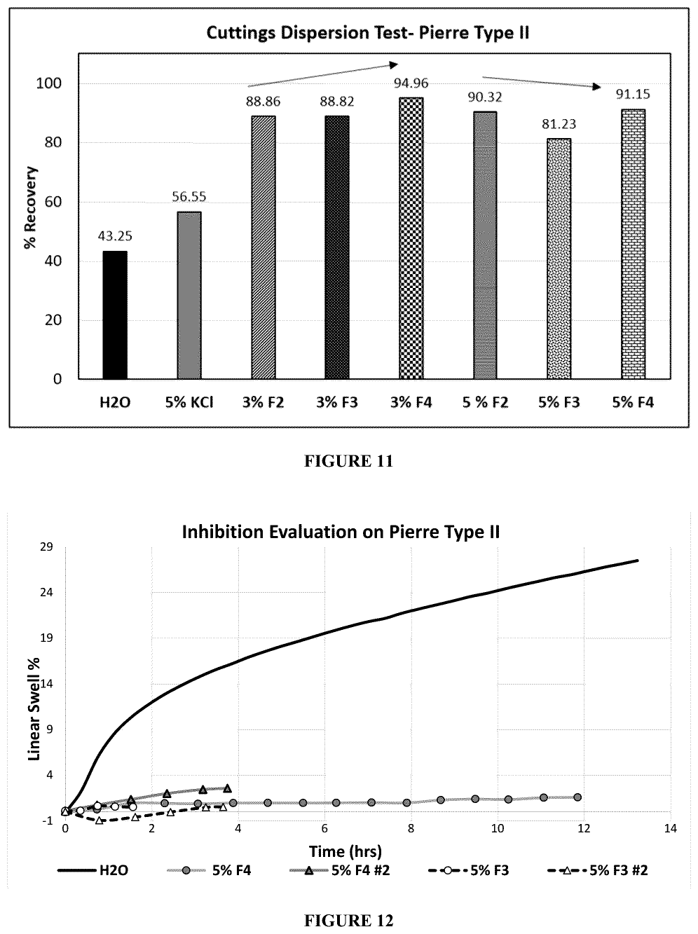

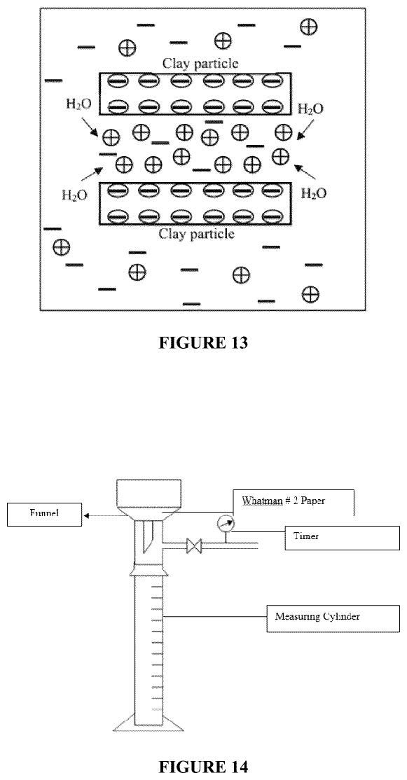

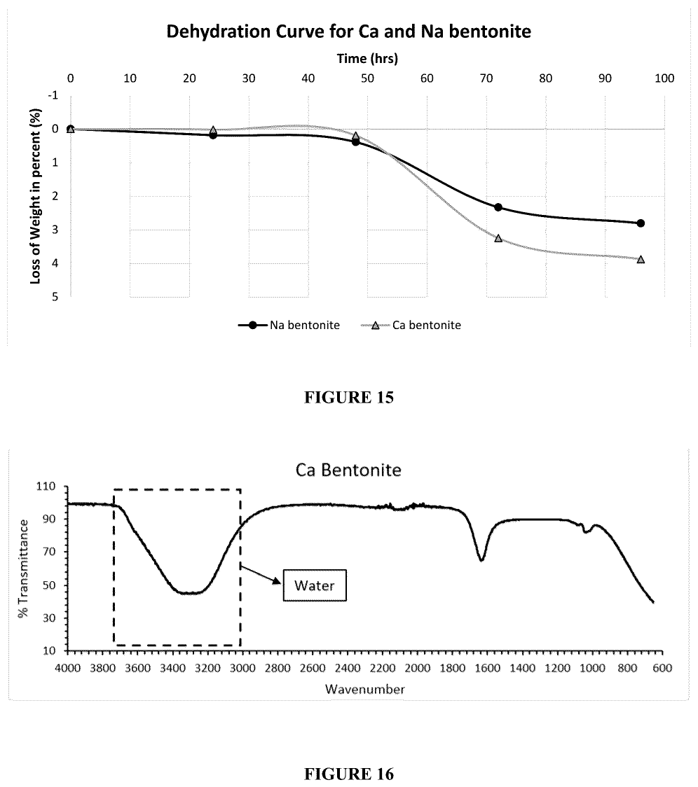

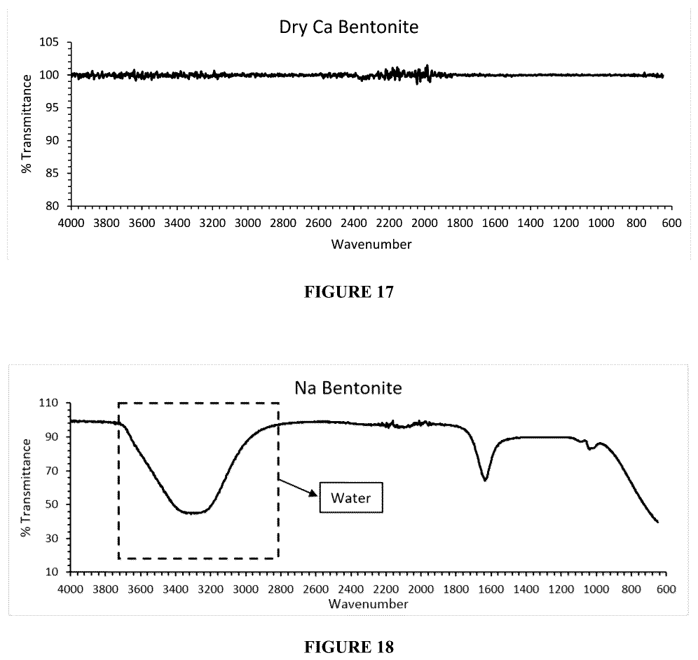

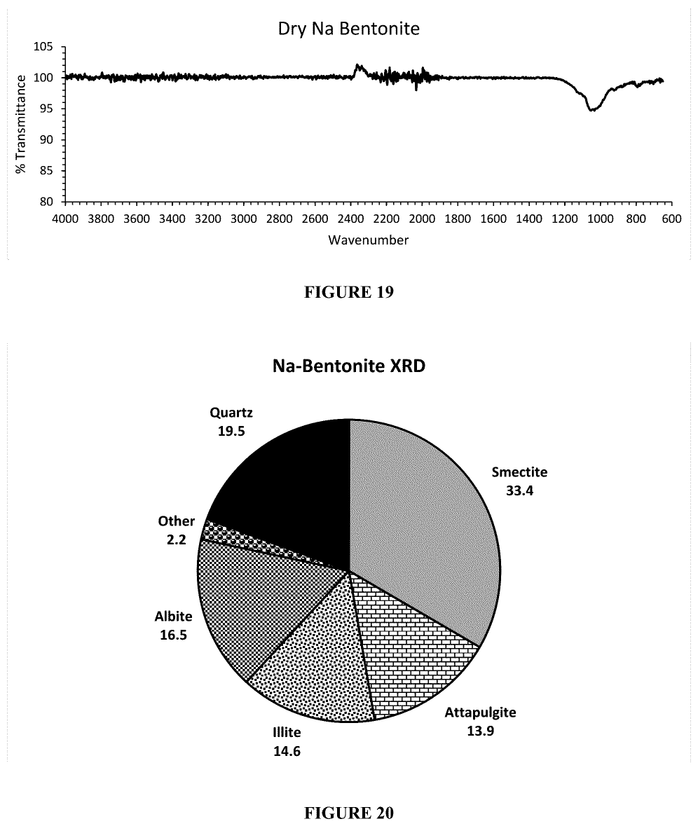

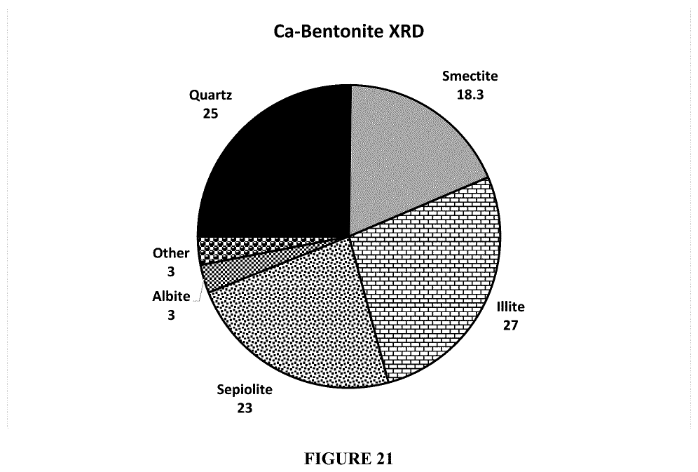

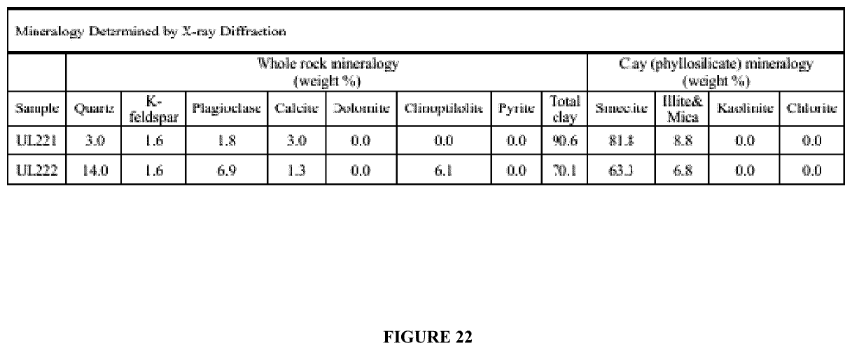

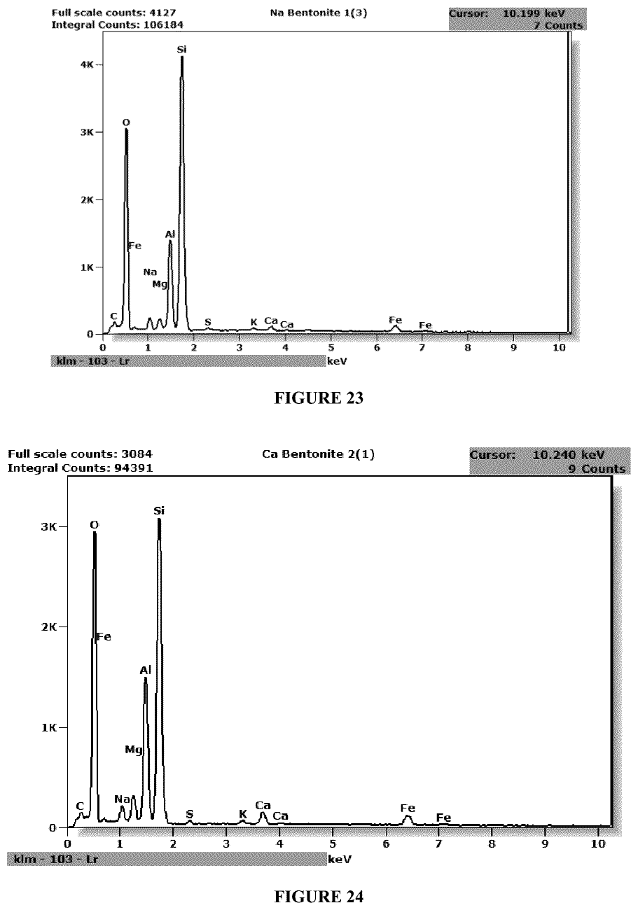

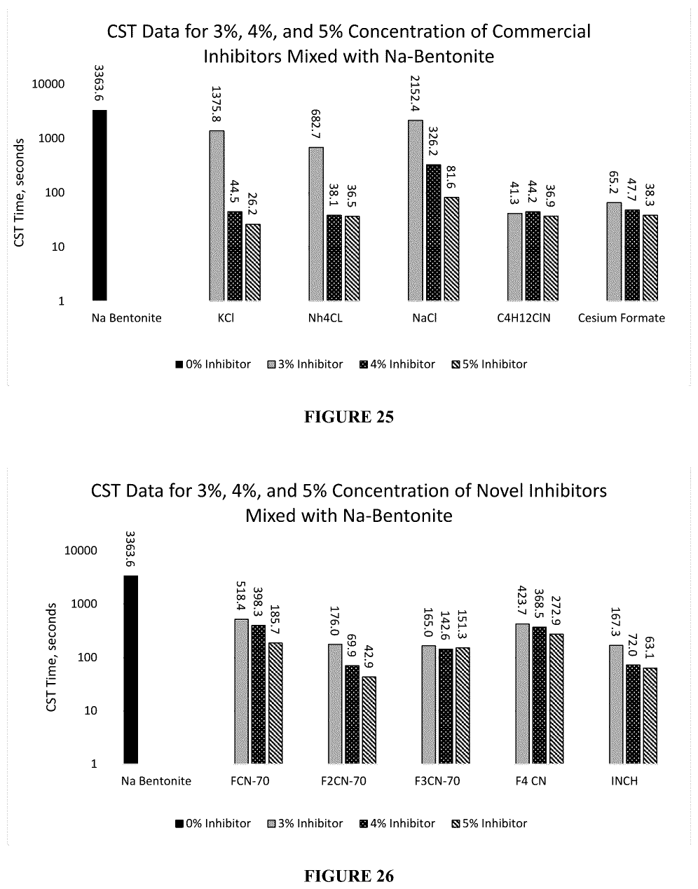

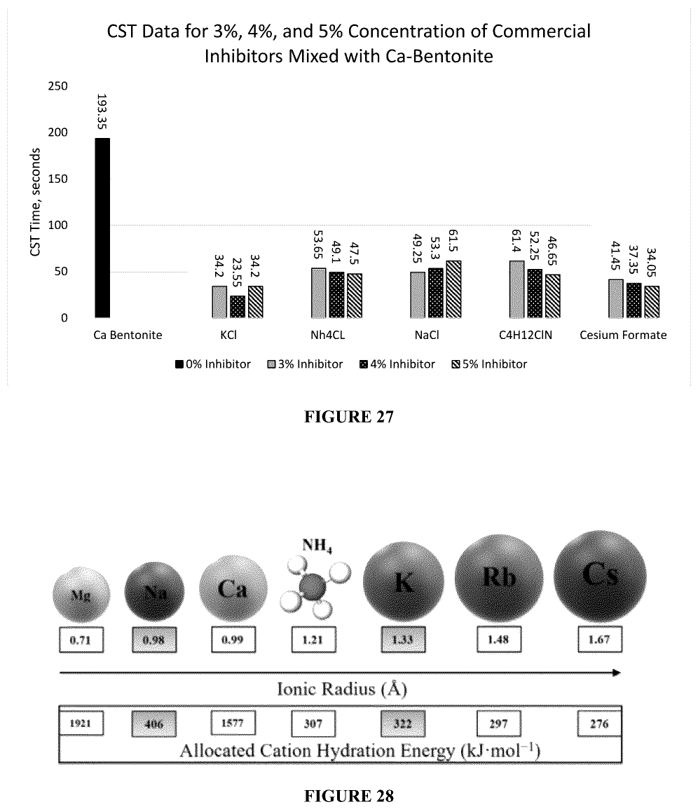

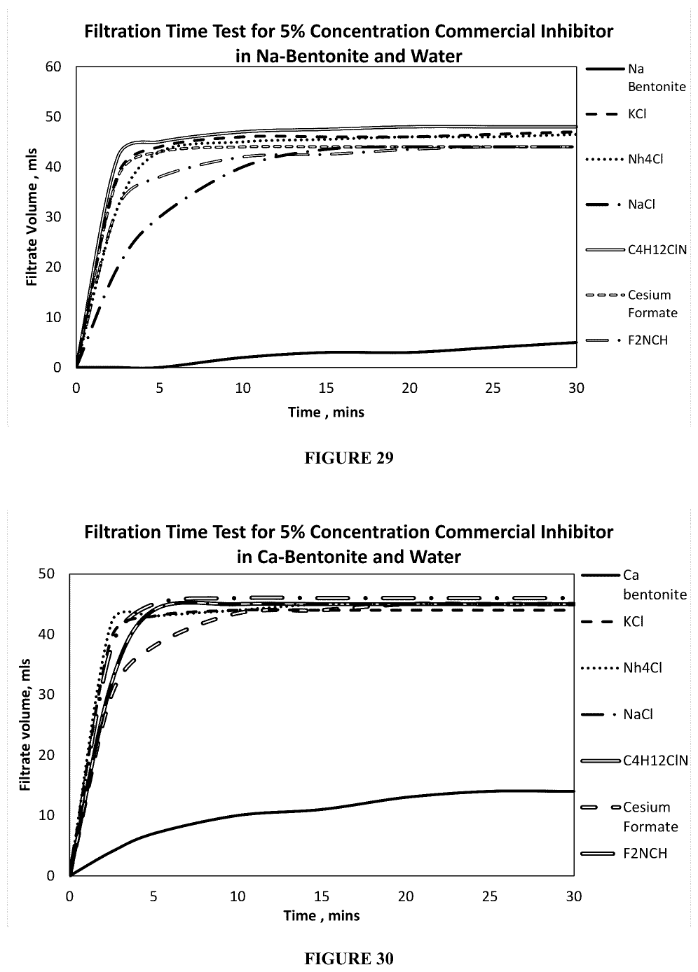

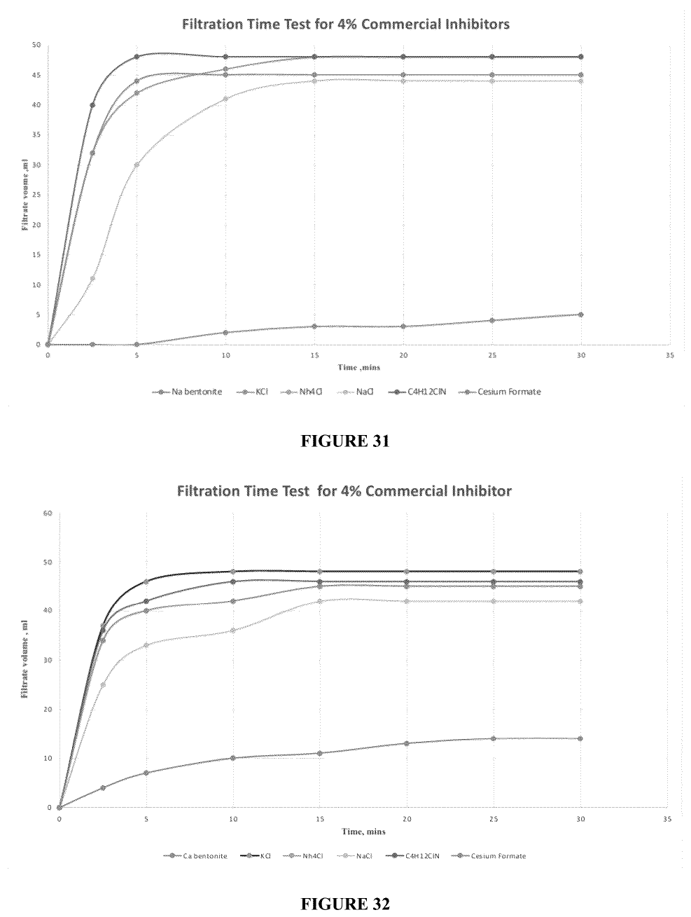

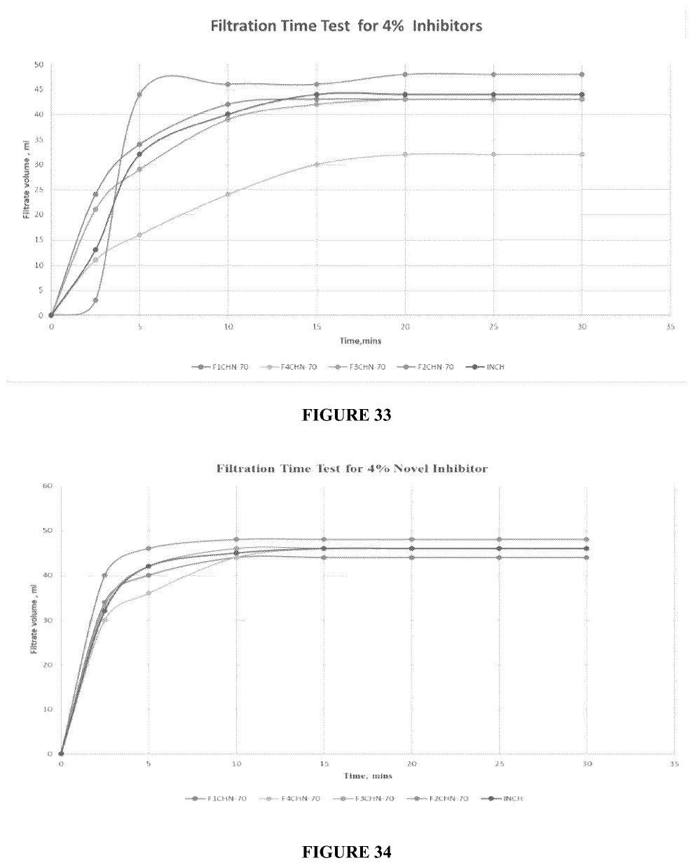

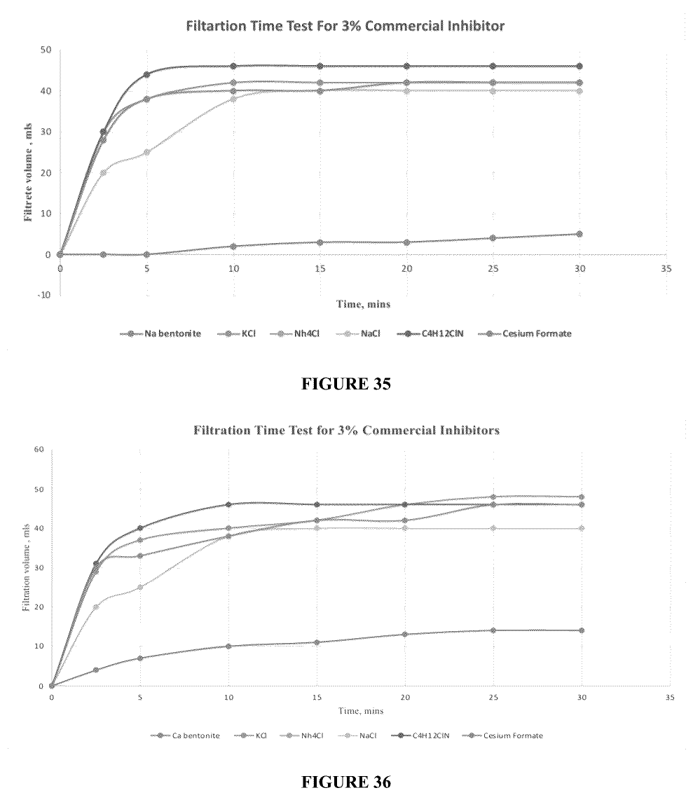

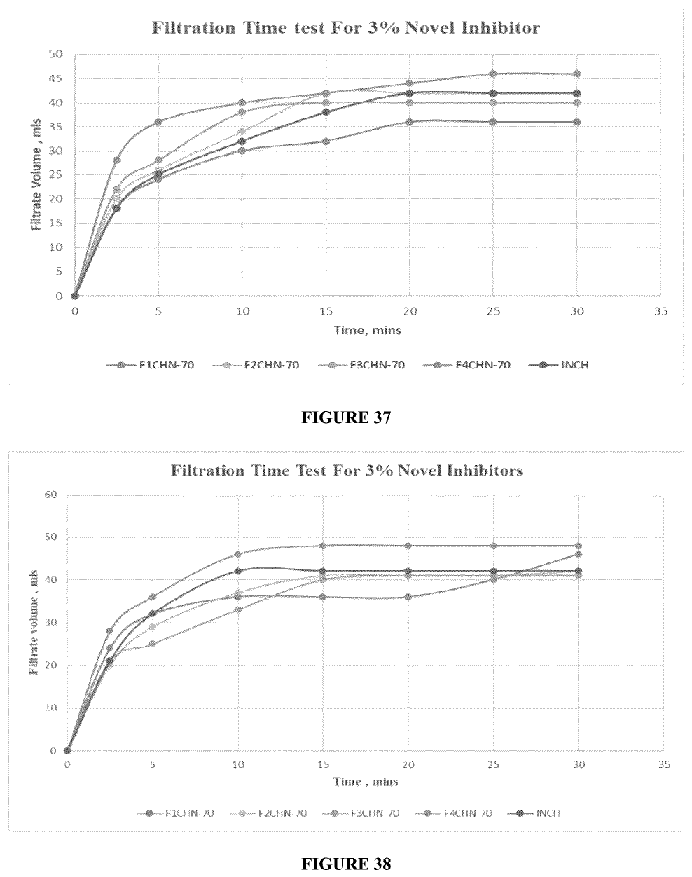

FIG. 12 shows an inhibition evaluation on the Pierre Type II. Results show that the swelling percentage of the shale sample was 28 for the water without inhibitor which was used as the baseline for the experimentation. The 3% F4CN-76 reduced the swelling percentage from 29% to 3% in 4 hours. The inhibition performance of the 5% F3CN-&0 was similar to that of the 3% F4CHN-70. 5% F4CHN-70 gave the best inhibition performance compared to all the other inhibitors. The inhibitor reduced the swelling percentage from 28% less than 2% in 12 hours. This shows a good inhibition performance by the 5% F4CHN-70.

### Rheological Properties Measurement WBDM

In order to ensure a successful drilling operation and wellbore stability, rheological properties of drilling muds need to be maintained. These properties include mud density, PV, apparent viscosity (AV), YP and gel strength. As shown in Table 12, the addition of inhibitors improved the rheological performance of WBM. There was no significant difference in performance between all the inhibitors, however the PV did better with 5% F2CHN-70. This shows that the inhibitors will be able to suspend cutting when used during drilling (Qu et al., 2009). This indicates that 3% F2CHN-70 and 3% F3CHN-70 performed equally better. Only the results from 5% F3CHN-70 showed 4 percentage points lower than the industry standards (85%). Results showed that the 5% F4CN inhibitor showed excellent suspending properties, preventing cutting accumulation at the bottom of the bit, which leads to the drill pipe sticking, resulting in oil well failure. The results are shown in Table 12.

TABLE 12
Rheological properties measurement
of WBDM mixed with inhibitors

| Products, | Mix | | F2 | F3 | F4 |
|---|---|---|---|---|---|
| lb/bbl | Time (min) | Original | 5% | 5% | 5% |
| Water | 10 min | — | 166.49 | 166.49 | 166.5 |
| 5% F2 | | — | 14.25 | — | — |
| 5% F3 | | — | — | 15.25 | — |
| 5% F4 | | — | — | — | 15.78 |
| | Units | 120° F. | 120° F. | 120° F. | 120° F. |
| Density | lb/gal | 12.5 | 12.5 | 12.5 | 12.5 |
| 600 RPM | D.R. | 57 | 43 | 44 | 43 |
| 300 RPM | D.R. | 42 | 33 | 31 | 31 |
| 200 RPM | D.R. | 35 | 27 | 23 | 25 |
| 100 RPM | D.R. | 28 | 22 | 19 | 8 |
| 6 RPM | D.R. | 9 | 8 | 7 | 8 |
| 3 RPM | D.R. | 8 | 7 | 6 | 7 |
| Plastic Viscosity | cP | 15 | 10 | 13 | 12 |
| Yield Point | lb/100 ft² | 27 | 23 | 18 | 19 |
| 10 Second Gel | lb/100 ft² | 9 | 7 | 7 | 7 |
| 10 Minute Gel | lb/100 ft² | 10 | 9 | 9 | 9 |
| 30 Minute Gel | lb/100 ft² | — | — | — | — |

TABLE 13
WPPF for Na Bentonite

| Method | WPPF (%) |
|---|---|
| Quartz | 2.30 |
| Bentonite | 1.06 |
| Montmorillonite | 4.41 |
| Palygorskite | 18.37 |
| Sepiolite | 10.54 |
| Albite | 22.90 |
| Illite-1M | 40.42 |

TABLE 14
WPPF for Ca bentonite

| Method | WPPF (%) |
|---|---|
| Quartz | 21.31 |
| Bentonite (Calcium) | 31.16 |
| Montmorillonite | 1.77 |
| Palygorskite | 14.51 |
| Sepiolite | 0.06 |
| Heulandite | 3.04 |
| Albite | 19.22 |
| Illite-1M | 8.94 |

### CONCLUSIONS

The results of the Capillary Suction Timer test and the Filtration time test showed that the Tetramethylammonium Chloride and Cesium formate gave the best results off inhibition with the commercial inhibitors. From the CST and Filtration time test results for a good inhibition performance to be achieved using NaCl and KCl a higher concentration has to be used. The F4CHN-70 and F3CN 70 gave the best inhibition performance with the Na bentonite from the results in the filtration time test, linear swelling meter test. The F3CN gave a good inhibition performance in the Ca bentonite than the F2CHN-70 and F4CHN-70 from the linear swelling meter test. There was a good swelling inhibition performance in the Na bentonite than in Ca bentonite using the F4CHN-70. The F4CHN-70, F3CHN-70 and F2CHN-70 showed a good cutting dispersion performance on the Pierre Type II shale samples. F4CHN-70 provided a good inhibition performance from the linear swelling meter test on Pierre Type II shale samples than F3CHN-70 and F2CHN-70. From the test on rheological The F4CHN-70, F3CHN-70 and F2CHN-70 all improved the rheological properties of the water based drilling mud. The novelty of the F4CHN-70 was achieved based on the inhibition performance on the Na bentonite and the Pierre Type II. The clay inhibitor compositions were found to be more effective inhibitors than the KCl which is mostly used. The advantages of the clay inhibitor compositions not only prevented the swelling of clay but also avoid the reduction of the rock formation permeability and porosity.

The excellent results of the rheological properties, such as Plastic viscosity, and Yield point obtained with the clay swelling inhibitors were compared with the results of the rheological properties obtained using potassium chloride as clay inhibitor in another sample of drilling fluid. Therefore, the results of the rheological properties such as Plastic viscosity and Yield point did not give a better suspending agent, that is, the drilling clay cuttings could not be able to be suspended to the surface to be separated physically before the drilling fluid or the water-based mud could accomplish the cycle back to downhole to continue the drilling, otherwise, if these cuttings not being suspended dissolves in the fluid while drilling, whose continuous phase is water, then the drilling fluid start swelling and changing its Physic-chemical properties such as the plastic viscosity and Yield point and Total dissolved solids (TDS). Therefore, the dispersion test, the rheological properties determinations, and the linear swelling test were preponderant to determine that the solid inhibitor F4CHN-70 was excellent.

The results of the solid F4CHN-70 generated the best results on sodium bentonite which is the most important clay used in drilling fluid and encountered in the rock formation during the drilling process. The results obtained using the liquid organic and inorganic inhibitor F2CHN-70 and F3CHN-70 in calcium bentonite were a little bit better than the organic and inorganic F4CHN-70; because the hydrogen bonding in calcium bentonite is stronger than the hydrogen bonding in sodium bentonite. The adsorption of water in sodium bentonite is much greater than in Calcium bentonite. The results of the F2CHN-70 and F3CHN-70 gave good results, but they were not as well as the F4CHN-70.

It is important to note that the results of the CST test, and the Filtration test, after accomplishing a good drying process above 200° C. in the oven, generated the least time possible for the CST indicating a good inhibition for F2CHN-70, and F3CHN-70 but the best time obtained in the CST—was for the solid inhibitor F4CHN-70.

During the test, the concentration used were 3, 4, and 5% using the commercial potassium chloride as a comparative study with inhibitors created and all the results were obtained under these concentrations. However, some of the tests done in Baker Hughes 3 and 5% were used mostly. The 4% was used but less due to the short time the student and the technical people of the laboratory had to finish all the tests organized in the lab.

The chemical combination of organic and inorganic compounds is interrelated between them so that the ionic bond is stronger than if the chemical products are used along, so a mixture can give a major cation exchange capacity due to the grouping of the cations together when they must interact chemically (CEC-Cationic exchange capacity)) with sodium bentonite or calcium bentonite in contact with water-based drilling mud. Therefore, technically the inhibitor added to the fluid will be acting as an anti-swelling agent, not allowing the water, the continuous phase (water contained in the drilling) to be adsorbed by the clay of sodium or calcium bentonite.

The code F1CHN-70 was for the formulation consisting of: 20 wt % of potassium acetate; 25 wt % cesium formate; and 55 wt % of polypropylene glycol. This combination did not give in the CST test a lower time, the time was too high, therefore, this formulation was eliminated after the testing process. It is important to know that the ionic radio of the metal can be considered for any of the formulations.

The code F2CHN-702 was for the formulation consisting of: 47 wt % potassium acetate 47% and 53 wt % cesium formate.

The code F3CHN-70 was for the formulation consisting of: 20 wt % of potassium acetate; 25 wt % of cesium formate; and 55 wt % of potassium citrate. The results of CST were good for this formulation.

The code F4CHN-70 was for the formulation consisting of: 50 wt % of calcium chloride; 20 wt % of potassium bicarbonate; and 30 wt % of potassium formate. The following chemicals can be used to optimize this formulation: potassium citrate, potassium carbonates, dipotassium glutarate, potassium fluoride, calcium hydroxide, sodium carbonate, and sodium chloride. Each one of these compounds can be used to increase its cation exchange capacity and behave rheological well.

One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. As used herein, use of the term “including” as well as other forms, such as “includes,” and “included,” is not limiting.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. It should also be appreciated that the numerical limits can be the values from the examples. Certain lower limits, upper limits and ranges appear in at least one claims below. All numerical values are “about” or “approximately” the indicated value, and consider experimental error and variations that would be expected by a person having ordinary skill in the art.

All patents, patent applications, provisional applications, and publications referred to or cited herein are incorporated by reference in their entirety, including all figures and tables, to the extent they are not inconsistent with the explicit teachings of this specification.

### REFERENCES

107857-MS. (n.d.). A. Patel, E. Stamstakis, S. Young, J. Friedheim, (2007). Advances in inhibitive water-based drilling fluids—can they replace oil-based muds.
Aboudi Mana, S. C., Hanafiah, M. M., Chowdhury, A. J. K. (2017). Environmental characteristics of clay and clay-based minerals. Geology, Ecology, and Landscapes, 1(3), 155-161. https://doi.org/10.1080/24749508.2017.1361128.
Agwu, O. E., Okon, A. N., and Udoh, F. D. (2015). A Comparative Study of Diesel Oil and Soybean Oil as Oil-Based Drilling Mud. Journal of Petroleum Engineering, 2015, 1-10. https://doi.org/10.1155/2015/828451.
Ahmad, H. M., Kamal, M. S., Al-Harthi, M. A. (2018). Effect of thermal aging and electrolyte on bentonite dispersions: Rheology and morphological properties. Journal of Molecular Liquids, 269, 278-286. https://doi.org/10.1016/j.molliq.2018.08.058.
Ahmadi, Ali Ahmaid; Shadizadeh, Seved Reza; Shah, Kalipit; Bahadori, Alireza; (2018). An accurate model to predict drilling fluid density at wellbore condition. Egyptian Journal of Petroleum.
Ahmed, H. M., Kamal, M. S., and Al-Harthi, M. (2019). Polymeric and low molecular weight shale inhibitors: A review. In Fuel (Vol. 251, pp. 187-217). Elsevier Ltd. https://doi.org/10.1016/j.fuel.2019.04.038.
Al-Ansari, A., Abuhamed, A. M., Abahusain, A., Pino, R., Aramco, S., el Bialy, M., and Zoghbi, B. (2016). the SPE Kingdom of Saudi Arabia Annual Technical Symposium and Exhibition.
Alexander, J. A., Ahmad Zaini, M. A., Surajudeen, A., Aliyu, E. N. U., Omeiza, A. U. (2019). Surface modification of low-cost bentonite adsorbents—A review. In Particulate Science and Technology (Vol. 37, Issue 5, pp. 534-545). Taylor and Francis Inc. https://doi.org/10.1080/02726351.2018.1438548.
Almubarak, T., Aldajani, O., Almubarak, M., & Aramco, S. (2015). A Collective Clay Stabilizers Review.
Alsabaa, A., Gamal, H., Elkatatny, S., & Abdulraheem, A. (2020). Real-time prediction of rheological properties of invert emulsion mud using adaptive neuro-fuzzy inference system. Sensors (Switzerland), 20 (6). https://doi.org/10.3390/s20061669.
A. M. Tehrani, et al. (2007). A water-based drilling fluid for HT/HP applications. Paper SPE105485 Presented at the 2007 SPE International Symposium on Oil Field Chemistry Held in Houston, Texas, USA.
Amaclule, J. O., Kersey, D. G., Norman, D. K., Shannon, P. M., Amacrule, J. O., Kersey, D. G., Laboralorlbs, C., Norman, D. K., & Shannon, P. M. (1988). ADVANCES IN FORMATION DAMAGE ASSESSMENT AND CONTROL STRATEGIES THIS IS A PREPRINT-SUBJECT TO CORRECTION ADVANCES IN FORMATION DAMAGE ASSESSMENT AND CONTROL STRATEGIES.
Amer, M., A.-B. M. A., & A. A. A. (2022). Calcium bentonite-based drilling mud with NaOH and Na2CO3 additives to improve the laboratory simulated cleaning process. Petroleum Science and Technology.
Anderson, R. L., Ratcliffe, I., Greenwell, H. C., Williams, P. A., Cliffe, S., & Coveney, P. v. (2010). Clay swelling-A challenge in the oilfield. In Earth-Science Reviews (Vol. 98, Issues 3-4, pp. 201-216). https://doi.org/10.1016/j.earscirev.2009.11.003.
ASME. (2005). SME (2005) Drilling fluids processing handbook. www.Fanarco.Net/Books/Drilling/Drilling_Fluids_Processing_Handbook.
Attia, M., E. W., D. (2010). new engineered approach to replace oilbased fluids with high performance water-based fluids in Mediterranean sea.
Auerbach S. M. (2004). Handbook of layered materials (Boca Raton, Ed.). CRC Press.
Kutlu, Bahri; Takach, Nicholas; Ozbayoglu, Evren M.; Miska, Stefan Z.; Yu, Mengjiao; Mata, Clara; (2017). Drilling fluid density and hydraulic drag reduction with glass bubble additives. J. Energy Resour. Technol. 139.
Bahrami, H., R. R., O. J., N. D., & C. B. (2011). Evaluation of damage mechanisms and skin factor in tight gas reservoir. OnePetro.
Balaban, R. de C., Vidal, E. L. F., & Borges, M. R. (2015). Design of experiments to evaluate clay swelling inhibition by different combinations of organic compounds and inorganic salts for application in water base drilling fluids. Applied Clay Science, 105-106, 124-130. https://doi.org/10.1016/j.clay.2014.12.029.
Berry, S. L., Boles, J. L., Brannon, H. D., & Beall, B. B. (2008). Performance Evaluation of Ionic Liquids as a Clay Stabilizer and Shale Inhibitor.
Blachier, C., Michot, L., Bihannic, L, Barrès, O., Jacquet, A., & Mosquet, M. (2009). Adsorption of polyamine on clay minerals. Journal of Colloid and Interface Science, 336 (2), 599-606. https://doi.org/10.1016/j.jcis.2009.04.021.
Bland, R., et al. (2006). HP/HT drilling fluids challenges. ADC/SPE.
Bloys, B. et al. (1994). Designing and managing drilling fluid. Oilfield Review 6.2.
Bock, E. S., C. P. V., & S. N. T. (1995). Monte Carlo molecular modeling studies of hydrated Li-, Na-, and K-smectites: Understanding the role of potassium as a clay swelling inhibitor. Journal of the American Chemical Societ, 50-117.
Bommer, P. M. (2008). A Primer of Oilwell Drilling. University of Texas at Austin.
Borchardt, H. J., Daniels, F. (1957). The Application of Differential Thermal Analysis to the Study of Reaction Kinetics.
Brewer. (1964). Fabric and mineral analysis of soil. Wiley.
Brigatti, M. F., Galán, E., & Theng, B. K. G. (2013). Structure and Mineralogy of Clay Minerals. In Developments in Clay Science (Vol. 5, pp. 21-81). Elsevier B.V. https://doi.org/10.1016/B978-0-08-098258-8.00002-X.
Buranaj Hoxha, B. (2016). How to Test Fluids for Shale Compatibility. https://www.researchgate.net/publication/306218580.
Chuprin, M., Chavez, N., Nath, F., & Mokhtari, M. (2020 Aug. 20). Evaluation of Tuscaloosa Marine Shale Stability Using Capillary Suction Time and Roller Oven Tests. https://doi.org/10.15530/urtec-2020-3098.
Civan, F. (1996). the SPE Formation Damage Control Symposium held in Lafayefte.
Civan, F. (2015). Reservoir formation damage. Gulf Professional Publishing.
Clay stabilization. (2015). In Petroleum Engineer's Guide to Oil Field Chemicals and Fluids (pp. 121-145). Elsevier.https://doi.org/10.1016/b978-0-12-803734-8.00003-5.
Cojocaru, M. O., B. M., G. A. M., C. C. M., & D. L. N. (2022). Nitriding in ammonia-nitrogen gaseous mixtures, after the simultaneous saturation with Ti and Al. International Journal of Surface Science and Engineering, 17-38.
D Carico, by R., Bagshaw, F. R., & Div Merck, K. (n.d.). SPE 7747 Description and Use of Polymers Used in Drilling, Workovers, and Completions.
Davidson, D. T., Mateos, M., & Barnes, H. F. (n.d.). Improvement of Lime Stabilization Of Montmorillonitic Clay Soils With Chemical Additives.
Dhar, V., Beg, M., Saxena, A., & Sharma, S. (2021). Capillary Suction Timer and machine learning techniques as tools for evaluating the performance of different shale inhibitors used in drilling mud. Journal of Natural Gas Science and Engineering, 96. https://doi.org/10.1016/j.jngse.2021.104301.
Dimataris, M. (2017). AADE Template.
Dobson, J., Harrison, J., Hale, A., Lau, H., Bernardi Jr, L., Kielty, J., Albrecht, M., Technology Co, P., & Bruner, S. (2000). Laboratory Development and Field Application of a Novel Water-Based Drill-In Fluid for Geopressured Horizontal Wells.
Du, W., W. X., C. G., Z. J., S. M. (2020). Synthesis, property and mechanism analysis of a novel polyhydroxy organic amine shale hydration inhibitor. Minerals 10.
El-Monier, I. A., Nasr-El-Din, H. A., Harper, T. L., Rosen, R. (2013). A New Environmentally Friendly Clay Stabilizer.
Energy graphics. (2014). How Petroleum and Natural Gas were formed.
Erdo [symbol] an, Y. (2015). Physicochemical properties of handere clays and their use as a building material. Journal of Chemistry, 2015. https://doi.org/10.1155/2015/374245.
F. Salles, J. M. D. R. D. O. B. M. J. I. B. H. V. D. (2009). Hydration sequence of swelling clays: evolutions of specific surface area and hydration energy. J. Colloid Interface Sci.
Friedheim, J., Young, S., de Stefano, G., Lee, J., Guo, Q., & Swaco, M.-I. (2012). SPE 157032 Nanotechnology for Oilfield Applications-Hype or Reality?
Gao, Y., Wang, Y., Chen, C., Zhou, J., Cheng, Y., & Shi, L. (2022). Preparation of Montmorillonite Nanosheets with a High Aspect Ratio through Heating/Rehydrating and Gas-Pushing Exfoliation. Langmuir, 38 (34), 10520-10529. https://doi.org/10.1021/acs.langmuir.2c01320.
Ghaedi, M. (2021). Fundamental Processes and Applications.
Ghavami, M.; Hasanzadeh, B.; Zhao, Q.; Javadi, S.; Kebria, D. Y.; (2018). Experimental study on microstructure and rheological behavior of organobentonite/oil-based drilling fluid. Journal of Molecular Liquids, 263, 147-157. https://doi.org/10.1016/j.molliq.2018.04.137
Gholami, R., Elochukwu, H., Fakhari, N., & Sarmadivalch, M. (2018). A review on borehole instability in active shale formations: Interactions, mechanisms and inhibitors. In Earth-Science Reviews (Vol. 177, pp. 2-13). Elsevier B.V. https://doi.org/10.1016/j.earscirev.2017.11.002.
Grim. (1968). Clay mineralogy (McGraw-Hill, Ed.; 2nd ed.).
Hancock, N. J., & T. A. M. (1978). Clay mineral diagenesis and oil migration in the Middle Jurassic Brent Sand Formation. Journal of the Geological Society.
Hassiba, K. J., & Amani, M. (2012). SPE 163315 Salinity Effect on the Rheological Properties of Water Based Mud under High Pressures and High Temperatures of Deep Wells.
Hendricks, S. B., & J. M. E. (1938). Structures of kaolin and talc-pyrophyllite hydrates and their bearing on water sorption of the clays. American Mineralogist: Journal of Earth and Planetary Materials.
Himes, R. E., Vinson, E. F., Simon, D. E., Services, H. (1991). Clay Stabilization in Low-Permeability Formations.
Hoxha, B. B., Sullivan, G., van Oort, E., Daigle, H. (n.d.). Determining the Zeta Potential of Intact Shales via Electrophoresis.
Hu, Z., Gao, M., Luo, Z., Ye, Y., Liu, Y., Lu, L. (2014). Wettability of compound organobentonites with ultra-low swelling modified by a series of bis-quaternary ammonium salts. Colloids and Surfaces A: Physicochemical and Engineering Aspects, 441, 685-694. https://doi.org/10.1016/j.colsurfa.2013.10.037.
J. L. Suter, P. V. C. R. L. A. H. C. G. S. C. (2011). Rule based design of clay-swelling inhibitors, Energy Environ. Sci.
Karpiński, B., & Szkodo, M. (2015a). Clay Minerals—Mineralogy and Phenomenon of Clay Swelling in Oil & Gas Industry. Advances in Materials Science, 15(1), 37-55. https://doi.org/10.1515/adms-2015-0006.
Karpiński, B., & Szkodo, M. (2015b). Clay Minerals—Mineralogy and Phenomenon of Clay Swelling in Oil & Gas Industry. Advances in Materials Science, 15(1), 37-55. https://doi.org/10.1515/adms-2015-0006.
Kloprogge. (1998). Synthesis of Smectites and Porous Pillared Clay Catalysts: A Review. Journal of Porous Materials. 5-41.
Kodikara, J., S. L. B. and D. G. F. (1999). Changes in clay structure and behaviour due to wetting and drying. Australian Geomechanics Society.
Laux, H., Meese, E., Mo, S., Unander, E., Johansen, S. T., Bansal, K. M., Danielson, T. J., Goldszal, A., & Monsen, J. I. (2008). OTC 19434 Multidimensional Simulations of Multiphase Flow for Improved Design and Management of Production and Processing Operation.
Li, J., Zhang, G., Li, G., Huang, Z., & Li, W. (2018). A Method to Double the Extension Ability of Radial Jet Drilling Technology. Journal of Solar Energy Engineering, Transactions of the ASME, 140 (9). https://doi.org/10.1115/1.4039977.
Lv, K.; Huang, P.; Zhou, Z.; Wei, X.; Luo, Q.; Huang, Z.; Yan, H.; & Jia, H. (2020). Study of Janus Amphiphilic Graphene Oxide as a High-Performance Shale Inhibitor and Its Inhibition Mechanism. Frontiers in Chemistry, 8. https://doi.org/10.3389/fchem.2020.00201.
Mahmoud, O., Nasr-El-Din, H. A., Vryzas, Z., & Kelessidis, V. C. (2018). Effect of ferric based drilling muds. SPE Drilling and Completion, 33 (4), 363-376. https://doi.org/10.2118/184572-PA oxide nanoparticles on the properties of filter cake formed by calcium bentonite.
Melton, H. R.; Smith, J. P.; Mairs H. L.; Bernier, R. F.; Garland, E.; Glickman, A. H.; Jones, F. V.; Ray, J. P.; Thomas, D. (2004). Environmental aspects of the use and disposal of nonaqueous drilling fluids associated with offshore oil & gas operations. OnePetro.
Mohamed, A. M. O. (2000). The role of clay minerals in marly soils on its stability. In Engineering Geology (Vol. 57). www.elsevier.nl/locate/enggco.
Molina, A., M. A., L. F. J., S.-B. L., & I.-Y. A. (2022). Historical Context and Present Energy Use in the Global Economy. Springer, Cham.
Muhammed, N. S., Olayiwola, T., & Elkatatny, S. (2021). A review on clay chemistry, characterization and shale inhibitors for water-based drilling fluids. Journal Of Petroleum Science and Engineering (Vol. 206). Elsevier B.V. https://doi.org/10.1016/j.petrol.2021.109043.
Murray, H. H. (2006). Chapter 6 Bentonite Applications. Developments in Clay Science (Vol. 2, Issue C, pp. 111-130). https://doi.org/10.1016/S1572-4352 (06) 02006-X.
Murray H. H. (2007). Applied clay mineralogy: occurrences, processing, and application of kaolins, bentonites, palygorskite-sepiolite, and common clays (Vol. 2). Elsevier.
Murtaza, M., Kamal, M. S., Hussain, S. M. S., Mahmoud, M., & Syed, N. A. (2020). Quaternary ammonium gemini surfactants having different spacer length as clay swelling inhibitors: Mechanism and performance evaluation. Journal of Molecular Liquids, 308. https://doi.org/10.1016/j.molliq.2020.113054.
Nolan, D. P. (2014). Handbook of fire and explosion protection engineering principles: for oil, gas, chemical and related facilities.
Norrish, K. (1954). The swelling of montmorillonite. Discussions of the Faraday society 18.
Patel, A. D., Swaco, M.-I. (2009). SPE 121737 Design and Development of Quaternary Amine Compounds: Shale Inhibition With Improved Environmental Profile.
Perez, F., & D. D. (2020). A molecular dynamics study of primary production from shale organic pores. SPE Journal.
Qu, Y., Lai, X., Zou, L., & Su, Y. (2009a). Polyoxyalkyleneamine as shale inhibitor in water-based drilling fluids. Applied Clay Science, 44(3-4), 265-268. https://doi.org/10.1016/j.clay.2009.03.003.
Qu, Y., Lai, X., Zou, L., & Su, Y. (2009b). Polyoxyalkyleneamine as shale inhibitor in water-based drilling fluids. Applied Clay Science, 44(3-4), 265-268. https://doi.org/10.1016/j.clay.2009.03.003.
Quainoo, A. K., Negash, B. M., Bavoh, C. B., Ganat, T. O., Tackie-Otoo, B. N. (2020). A perspective on the potential application of bio-inhibitors for shale stabilization during drilling and hydraulic fracturing processes. In Journal of Natural Gas Science and Engineering (Vol. 79). Elsevier B.V. https://doi.org/10.1016/j.jngse.2020.103380.
R. de C. Balaban, E. L. F. V. M. R. B. (2015)., Design of experiments to evaluate clay swelling inhibition by different combinations of organic compounds and inorganic salts for application in water base drilling fluids.
Rahman, M. T., Negash, B. M., Moniruzzaman, M., Quainoo, A. K., Bavoh, C. B., Padmanabhan, E. (2020). An Overview on the potential application of ionic liquids in shale stabilization processes. In Journal of Natural Gas Science and Engineering (Vol. 81). Elsevier B.V. https://doi.org/10.1016/j.jngse.2020.103480.
Reuland, G., S. I., D. H., S. S., M. E. (2022). Assessment of the carbon and nitrogen mineralisation of digestates elaborated from distinct feedstock profiles.
Riffaldi, R., S. A., & L.-M. R. (1996). Carbon mineralization kinetics as influenced by soil properties.
Rojas, J. C., C. D. E., G. B., Z. J. (2006). Optimized salinity delivers improved drilling performance. In AADE 2006 Fluids Conference.
Ruedrich, J., Bartelsen, T., Dohrmann, R., Siegesmund, S. (2011). Moisture expansion as a deterioration factor for sandstone used in buildings. Environmental Earth Sciences, 63 (7), 1545-1564. https://doi.org/10.1007/s12665-010-0767-0.
Sawhney, B. L. (1972). Selective Sorption and Fixation of Cations by Clay Minerals: A Review. Clays and Clay Minerals, 20 (2), 93-100. https://doi.org/10.1346/CCMN.1972.0200208.
Seyedmohammadi, J. (2017). The effects of drilling fluids and environment protection from pollutants using some models. Modeling Earth Systems and Environment, 3 (1). https://doi.org/10.1007/s40808-017-0299-7.
Shan, W., Tao, S., Fu, F., Yuc, W., Zhao, Z. (2014). Research on the drilling fluid technology for high temperature over 240° C. Procedia Engineering, 73, 218-229. https://doi.org/10.1016/j.proeng.2014.06.191.
Stephens, M., Swaco, M.-I., Gomez-Nava, S., Churan, M. (n.d.). AADE 2009-NTCE-11-04: LABORATORY METHODS TO ASSESS SHALE REACTIVITY WITH DRILLING FLUIDS.
van Oort, E. (2018). How to Test for Compatibility Between Fluids and Shales.
Wangler, T., & Scherer, G. W. (2008).
Clay swelling mechanism in clay-bearing sandstones. Environmental Geology, 56 (3-4), 529-534. https://doi.org/10.1007/s00254-008-1380-3.
Weaver, J. D., Nguyen, P. D., & Loghry, R. A. (2011). SPE 149218 Stabilizing Fracture Faces in Water-Sensitive Shale Formations.
Xiong, H., & Devegowda, D. (2020 Aug. 20). Insights into Salinity Variations for Waterfloods, Frac-Fluids and Drilling Mud in Clay-Hosted Pores using Molecular Simulations. https://doi.org/10.15530/urtec-2020-2909.
Xu, C., Kang, Y., You, Z., Chen, M. (2016). Review on formation damage mechanisms and processes in shale gas reservoir: Known and to be known. In Journal of Natural Gas Science and Engineering (Vol. 36, pp. 1208-1219). Elsevier B.V. https://doi.org/10.1016/j.jngse.2016.03.096.
Yuan, G., Cao, Y., Schulz, H. M., Hao, F., Gluyas, J., Liu, K., Yang, T., Wang, Y., Xi, K., Li, F. (2019). A review of feldspar alteration and its geological significance in sedimentary basins: From shallow aquifers to deep hydrocarbon reservoirs. In Earth-Science Reviews (Vol. 191, pp. 114-140). Elsevier B.V. https://doi.org/10.1016/j.earscirev.2019.02.004.
Zhong, H., Qiu, Z., Huang, W., Cao, J. (2012a). Poly (oxypropylene)-amidoamine modified bentonite as potential shale inhibitor in water-based drilling fluids. Applied Clay Science, 67-68, 36-43. https://doi.org/10.1016/j.clay.2012.06.002.
Zhong, H., Qiu, Z., Huang, W., Cao, J. (2012b). Poly (oxypropylene)-amidoamine modified bentonite as potential shale inhibitor in water-based drilling fluids. Applied Clay Science, 67-68, 36-43. https://doi.org/10.1016/j.clay.2012.06.002.
Zhong, H., Qiu, Z., Huang, W., Cao, J. (2012c). Poly (oxypropylene)-amidoamine modified bentonite as potential shale inhibitor in water-based drilling fluids. Applied Clay Science, 67-68, 36-43. https://doi.org/10.1016/j.clay.2012.06.002.

What is claimed is:

1. A clay swelling inhibitor composition, wherein the composition comprises:
calcium chloride, wherein the calcium chloride is present in the clay swelling inhibitor composition from about 40 wt % to about 60 wt %;
potassium bicarbonate, wherein the potassium bicarbonate is present in the clay swelling inhibitor composition from about 15 wt % to about 25 wt %;
potassium formate, wherein the potassium formate is present in the clay swelling inhibitor composition from about 25 wt % to about 35 wt %; and
additives.

2. The clay swelling inhibitor composition of claim 1, wherein the composition comprises:
calcium chloride, wherein the calcium chloride is present in the clay swelling inhibitor composition at about 48 wt % to about 52 wt %;
potassium bicarbonate, wherein the potassium bicarbonate is present in the clay swelling inhibitor composition at about 18 wt % to about 22 wt %;
potassium formate, wherein the potassium formate is present in the clay swelling inhibitor composition at about 28 wt % to about 32 wt %; and
additives.

3. A clay swelling inhibitor composition, wherein the composition comprises:
potassium citrate, wherein the potassium citrate is present in the clay swelling inhibitor composition about 50 wt % to about 60 wt %;
cesium formate, wherein the cesium formate is present in the clay swelling inhibitor composition from about 20 wt % to about 30 wt %;
potassium acetate, wherein the potassium acetate is present in the clay swelling inhibitor composition from about 15 wt % to about 25 wt %; and
additives.

4. The clay swelling inhibitor composition of claim 3, wherein the composition comprises:
potassium citrate, wherein the potassium citrate is present in the clay swelling inhibitor composition at about 53 wt % to about 57 wt %;
cesium formate, wherein the cesium formate is present in the clay swelling inhibitor composition at about 23 wt % to about 27 wt %;
potassium acetate, wherein the potassium acetate is present in the clay swelling inhibitor composition at about 18 wt % to about 22 wt %; and
additives.

5. A method of treating a well or subterranean formation, the method comprising:
injecting a clay swelling inhibitor composition into a wellbore, wherein the clay swelling inhibitor composition comprises:
cesium formate, wherein the cesium formate is present in the clay swelling inhibitor composition from about 40 wt % to about 60 wt %;
potassium acetate, wherein the potassium acetate is present in the clay swelling inhibitor composition from about 25 wt % to about 50 wt %; and
additives.

6. A method of treating a well or subterranean formation, the method comprising:
injecting a clay swelling inhibitor composition into a wellbore, wherein the clay swelling inhibitor composition comprises:
polypropylene glycol, wherein the polypropylene glycol is presented in the swelling inhibitor composition from about 45 wt % to about 60 wt %;
cesium formate, wherein the cesium formate is present in the clay swelling inhibitor composition from about 15 wt % to about 30 wt %;
potassium acetate, where the potassium acetate is present in the clay swelling inhibitor composition from about 15 wt % to about 30 wt %; and
additives.

7. The method of claim 6, wherein the clay swelling inhibitor composition comprises:
polypropylene glycol, wherein the polypropylene glycol is presented in the swelling inhibitor composition of about 53 wt % to about 57 wt %;
cesium formate, wherein the cesium formate is present in the clay swelling inhibitor composition of about 23 wt % to about 27 wt %;
potassium acetate, where the potassium acetate is present in the clay swelling inhibitor composition of about 18 wt % to about 22 wt %; and
additives.
